(19) United States
(12) Patent Application Publication
(10) Pub. No.: US 2005/0165185 A1
(43) Pub. Date: Jul. 28, 2005

(54) Preparation of a conjugated molecule and materials for use therein

(76) Inventors: Alan Christopher Spivey, London (GB); David James Turner, Sheffield (GB); Domenico Carlo Cupertino, Manchester (GB); Remi Manouk Anemian, Manchester (GB); Stephen George Yeates, Manchester (GB)

Correspondence Address: MORGAN LEWIS & BOCKIUS LLP, 1111 PENNSYLVANIA AVENUE NW, WASHINGTON, DC, 20004, US

(21) Appl. No.: 10/511,625

(22) PCT Filed: Apr. 17, 2003
(86) PCT No.: PCT/GB03/01664

(30) Foreign Application Priority Data
Apr. 18, 2002 (GB) 02088763
Apr. 18, 2002 (GB) 02088755

(51) Int. Cl. C08F 4/44

(52) U.S. Cl. 526/191

(57) ABSTRACT

A method for preparing a conjugated molecule comprising a first monomer coupled to a second monomer, said method comprising: (i) linking the first monomer to a solid support via the germanium atom of a germyl linking group; (ii) coupling the first monomer to the second monomer in a coupling position to form a bound conjugated molecule, wherein the second monomer has a protecting group in a non-coupling position;
(iii) optionally sequentially coupling a third, fourth . . . and n^{th} monomer to the second, third and (n−1)^{th} monomer respectively; (iv) removing the protecting group; and (v) ipso-degermylation to release the bound conjugated molecule.

The present invention relates to a method for preparing a conjugated molecule such as a conjugated polymer or oligomer (in particular a polyaryl, polyheterocycle (e.g. polyheteroaryl) or oligoheterocycle including a block oligoheterocycle) comprising an improved coupling step.

Electroactive materials such as polyheteroaryls and oligoheteroaryls are gaining widespread academic and commercial interest due to their optical and electronic properties which may allow exploitation in electronic devices such as transistors (e.g. field effect transistors FETs useable in mobile phones, calculators, smart cards, etc) and LED's. For example, organic semiconductors have the potential advantage over inorganic semiconductors of low cost fabrication and patterning, large area fabrication and greater scope for tuning. Alternatively, synthesis from acyclic precursors can lead to high purity compounds but can be highly convoluted and significant material losses must be tolerated.

Successful organic semiconductors are likely to have a significant degree of control in regioregularity so as to allow efficient alignment and ordering in the solid state. As electrical performance of such materials improve, their manufacture is set to become one of the major speciality chemical opportunities of this century.

Although solution phase chemistry may be used to target polyheterocycles and oligoheterocycles using repetitive coupling reactions, the purification strategies required to meet the requisite levels of purity are inefficient rendering the methods of questionable commercial applicability. Moreover conventional methods for preparing oligoheterocycles (such as oligothiophenes) using solution phase cross-coupling (e.g. Suzuki, Kharasch, Stille or Negishi type processes) are plagued by undesirable side reactions such as homocoupling and loss of functional groups making purification arduous and inefficient.

It is desirable therefore to provide a process which allows control over the number of monomer units incorporated into the oligomer chains and/or the sequence of monomer units if more than one type of monomer unit is present.

The advantages of solid phase chemistry, i.e. chemistry using solid supports, over solution phase chemistry include ease of purification, amenability to automation, the ability to use excess reagents to drive reactions to completion without the penalty of making purification tedious and dilution effects (site isolation) which prevent homocoupling. For these reasons, solid phase synthesis is seen as an attractive alternative for preparing polyheterocycles and oligoheterocycles on a large scale but as yet has undergone little investigation. Synthesis on a solid polymer support necessitates two additional steps to solution phase synthesis, namely covalent attachment of the first monomer to the support via a linker and cleavage of the polymer from the support.

It is desirable that on cleavage the linker group be eliminated from the conjugated molecule and optionally replaced by a functional group for use in a further reaction.

One drawback of the application of solid phase synthesis is that on cleavage from the resin/linker an undesirable functional group may be left on the molecule that may be deleterious to the performance of the polymer material. Attachment in known processes is typically via “protecting group” based linkers meaning that a functional group (e.g. OH, COOH) incorporated in the first monomer is regenerated on polymer cleavage. Such functionality may be undesirable for the envisaged applications. For example, Malenfant and Fr\dot{e}chet, Chem. Commun, 1998, 2657-2658 disclose the synthesis of asymmetric oligothiophenes bound by an ester linkage to a chlormethylated macroporous resin using alternating bromination and Stille coupling reactions. Malenfant utilizes a Wang resin (1 in FIG. 1) which leaves an ester that requires subsequent decarboxylation. A similar resin supported preparation of benzyl ester capped polythiophenes is disclosed in Kirchbaum et al, Synthetic Metals, 119 (2001), 127-128 using alternating Suzuki/iodination coupling steps. Bäuerle et al, J. Org. Chem., 2000, 65, 352-359 avoided this complication using a silicon-based linker (2 in FIG. 1) that allowed traceless cleavage via ipso-protodesilylation, i.e. replacement of silyl group by a proton.

Thus viewed from one aspect the present invention provides a method for preparing a conjugated molecule comprising a first monomer coupled to a second monomer, said method comprising:
(A) linking the first monomer to a solid support via the germanium atom of a germyl linking group;
(B) if necessary activating a position on the first monomer and coupling the first monomer to a second monomer in a coupling position to form a bound conjugated molecule, wherein the second monomer has a protecting group in a non-coupling position if necessary repeating this coupling to obtain a higher degree of conversion;
(C) optionally removing the protecting group and repeating (B) with one or more further monomer molecules one or more times, optionally using monomer molecules without protecting groups or removing protecting groups as required if present
(D) if desired removing the protecting group; and
(E) ipso-degermylation to release the bound conjugated molecule.

By ipso-degermylation is meant replacing the germyl group by a proton or other group which may be a functional group permitting further reaction.

The product may be a homopolymer or copolymer.

Preferably the solid phase synthesis of the conjugated molecules such as polyaryls or polyheterocycles is improved by using a “double coupling strategy” which permits multiple coupling reactions for a single coupling step such that the level of coupling may be driven to high levels to increase purity of the final product. The present invention also provides a solid phase synthesis of conjugated molecules in which a first monomer linked to a solid support by a germyl linking group is coupled to a protected second monomer whose protecting group renders the coupled product inert to subsequent coupling.

Thus, in such solid phase chemistry a solid support which comprises bound germyl linking groups is coupled with the first monomer optionally in at least two successive stages to maximise the proportion of the germyl groups so coupled with the first monomer and coupling of each monomer (or subsequent oligomer) linked to the support to subsequent protected monomers may be carried out in at least two successive stages to maximise the proportion of the linked monomer or oligomer which is reacted. Should a coupling group be lost before completion of the reaction with the second or subsequent monomer it is preferable, if possible, to reform the group and to react again with the said monomer until the desired product is obtained. By these means the uniformity of the product is maximised.

The term conjugated molecule is intended to cover high or low molecular weight polymers and co-polymers including oligomers and co-oligomers. Preferably the conjugated molecule is a conjugated oligomer. Typically the method may be used to synthesise a range of conjugated molecules from simple dimers to more complex block co-polymers (such as block co-oligomers).

The term monomer is intended to cover single monomer units or a block of monomer units.

In an embodiment of the invention, each of the first, second and n^{th} monomers are capable of contributing to the-system of the conjugated molecule. For example, the first, second and n^{th} monomer may be independently selected from the group of monomer units consisting of an unsaturated monocyclic or polycyclic (e.g. fused polycyclic) hydrocarbon (e.g. a carboaromatic) monomer unit which is optionally ring substituted, an unsaturated monocyclic or polycyclic (e.g. a fused polycyclic) heterocyclic (e.g. heteroaromatic) monomer unit which is optionally ring substituted, an unsaturated acyclic hydrocarbon bridging monomer unit and a heteroatomic (or polyheteroatomic) bridging monomer unit. The first, second and n^{th} monomer may be the same or different. Optional ring substituents may be chosen to enhance the electronic (or other) properties of the conjugated molecule (e.g. a substituent which has an electron withdrawing or donating effect).

Preferably the conjugated polymer is a polyheterocycle, wherein at least one of the first, second and n^{th} monomers (preferably at least the first monomer) is an optionally ring substituted heterocyclic monomer unit. Preferably more than one of (e.g. all of) the first, second and n^{th} monomers is an optionally ring substituted heterocyclic monomer unit. Preferably at least one of the first, second and n^{th} monomers is a 5- or 6-membered optionally ring substituted heterocyclic monomer unit. The optionally ring substituted heterocyclic monomer unit may contain one, two or three heterocyclic atoms which may be the same or different. Preferably the (or each) heterocyclic atom is selected from the group consisting of nitrogen, sulphur, oxygen, phosphorous and selenium, preferably the group consisting of nitrogen, oxygen and sulphur, particularly preferably the group consisting of nitrogen and sulphur.

The term polyheterocycle is intended to cover high or low molecular weight polymers and co-polymers including oligomers and co-oligomers. Preferably the polyheterocycle is an oligoheterocycle. Typically the method may be used to synthesise a range of polyheterocycles from simple dimers to more complex block co-polymers (including block co-oligomers).

Preferably at least one of the first, second and n^{th} monomers (preferably at least the first monomer) is an optionally ring substituted unsaturated monocyclic or polycyclic (e.g. fused polycyclic) hydrocarbon (e.g. a carboaromatic) monomer unit. For example, the conjugated molecule may be a polyaryl. Particularly preferably at least one of the first, second and n^{th} monomers is an optionally ring substituted phenylene, styryl or anilino monomer unit suitably of formula —Ar′NAr ′″Ar″— is present, the groups Ar′, Ar′″ and Ar″ being aryl groups, in which the aryl groups may be phenyl groups. Ar′″ may be substituted (e.g. o- or p-substituted) with a group which has an electron withdrawing or donating effect.

Preferably at least one of the first, second and n^{th} monomers is an unsaturated acyclic hydrocarbon bridging monomer unit selected from the group consisting of alkeno and alkyno bridging monomer units. Preferably the unsaturated acyclic hydrocarbon bridging monomer unit is of formula [CR═CR]ₙ (where n is 1 to 5, preferably 1 to 3 and R is hydrogen or a C₁₋₆-alkyl group) or [C≡C]ₘ (where m is 1 to 3). Preferred examples are etheno, ethyno and buta[1,3]dieno bridging monomer units.

By way of example, at least one of the first, second and n^{th} monomers, i.e. any of the monomers, is selected from the group of monomer units consisting of optionally ring substituted thiophene, furan, pyridine, imidazole, isothiazole, isooxazole, pyran, pyrazine, pyridazine, pyrazole, pyridine, pyrimidine, triazole, oxadiazole, pyrrole, indazole, indole, indolizine, pyrrolizine, quinazoline, quinoline and phenyl. Preferably at least one of (preferably more than one of) the first, second and n^{th} monomer units is selected from the group consisting of optionally ring substituted thiophene and pyridine and particularly preferably is thiophene which may be substituted at the 3- or 4-position with an alkyl group (e.g. a C₁₋₁₂-alkyl such as a hexyl or octyl) or an aryl (e.g. a phenyl) group.

If desired at least one of the first, second and n^{th} monomers (preferably the first and second monomer) may be a block of monomer units, each monomer unit being as hereinbefore defined.

The conjugated molecule typically comprises up to 20, preferably up to 10 monomer units.

Two directional synthesis may be possible if the first monomer has two reactive positions. For example, where the first monomer is thiophene linked to germanium at the 3-position, it may be possible to simultaneously couple at positions 2- and 5-without separate synthetic steps.

Although any suitable protecting group may be used to protect the non-coupling position of the second monomer, silyl based protecting groups are preferred to exploit favourable differences in reactivity between germanium and silicon. Examples include Me₃Si (TMS), Et₃Si, ⁱPr₃Si, Me₂^{t}BuSi, Me₂PhSi. A particularly preferred example is TMS (trimethyl silane) or tert. butyl dimethyl silane. Corresponding silyloxy groups may also be used.

Step (D) may be carried out before, after or simultaneously with step (E) leading to symmetrically end functionalised or—telechelic molecules with useful end functionality. A silyl protecting group may be removed in step (C) nudeophilically with basic sources (e.g. K₃PO₄ or Cs₂CO₃) and/or fluoride sources (e.g. CsF or ⁿBu₄NF) or electrophilically (e.g. using electrophiles described below).

The ipso-degermylation of step (D) may be ipso-protodegermylation or electrophilic ipso-degermylation (e.g. ipso-halodegermylation).

By way of example, ipso-protodegermylation may be carried out using a strong organic acid (for example trifluoroacetic acid (TFA), HCO₂H, ACOH, ClCH₂CO₂H or Cl₂CHCO₂H), a mineral acid (for example HCl, H₂SO₄ or HF) or a source of fluoride ions (for example CsF or Bu₄NF) with conditions generally milder than those used for removal of the protecting group for example a silyl group.

Electrophilic ipso-degermylation may be carried out using a source of halonium ions (F⁺, Cl⁺, Br⁺ or I⁺), NO⁺, NO₂⁺, SO₃⁺, RCO⁺, RSO₂⁺, BHal₂⁺(e.g. BCl₂⁺) or B(OH)₂⁺. Where conditions are mild, the protecting group may be left intact to release a protected conjugated molecule. Subsequent removal of the protecting group in step (C) using a different electrophile leads advantageously to an unsymmetrical conjugated molecule. Under more forcing conditions, the protecting group may be removed simultaneously (e.g. electrophilic ipso-desilylation) advantageously releasing a symmetrically end functionalised conjugated molecule.

ipso-halodgermylation may be carried out using a source of halonium ions (X⁺). For example, ipso-bromodegermylation may be carried out using a source of bromonium ions (Br⁺) such as bromine or N-bromosuccinimide (NBS), ipso-iododegermylation using a source of iodonium ions (I⁺) such as iodine, ICI or N-iodosuccinimide (NIS) and ipso chlorodegermylation using a source of chloronium ions (Cl⁺) such as N-chlorosuccinimide (NCS), dichloramine-T or chlorine. In the case of polymers and oligomers which are not adversely affected by oxidising conditions an advantageously cheap and therefore preferred step for preparing halonium ions is to use a group I metal halide together with an oxidant. For example, NaBr may be used with an oxidant such as H₂O₂ or (preferably) dichloramine-T to produce bromonium ions.

In a preferred embodiment, step (E) comprises:
ipso-degermylation using a functionalised block conjugated polymer AY.

This embodiment advantageously releases block co-oligomers with varying (but precisely defined) topology. Preferably compound AY is a functionalised block conjugated polymer (or a functionalised block conjugated oligomer) wherein the block conjugated polymeric group Y is preferably a block of monomeric units as hereinbefore defined. For example, group Y may be a dimeric, trimeric, tetrameric, pentameric or hexameric thiophene or pyridine block. Functionality A is typically bromine or iodine preferably bromine.

New C—C bonds may be advantageously formed by ipso-degermylative cleavage to leave an end capping group which may be tailored to introduce desirable electronic properties to the conjugated molecule. For example, ipso-degermylation may be carried out using a source of acylium ions such as a Freidel-Crafts reagent (e.g. carboxylic acid chloride and Lewis acid) to leave a ketone end group. For example, ipso-degermylation may be carried out using germyl-Stille type cleavage with an aryl, heteroaryl, vinyl, benzyl, allyl, alkynyl or propargyl halide (I, Br or Cl), sulphonate ester (triflate, nosylate, mesylate or tosylate) or diazonium salt (N₂⁺) in the presence of a catalytic amount of Pd(0) having suitable ligands (e.g. phosphine ligands) and a reagent capable of rendering germanium hypervalent (e.g. a source of fluoride ions such as CsF or Bu₄NF) to leave an aryl, heteroaryl, vinyl, benzyl, allyl, alkynyl or propargyl end group respectively. Generally ipso degermylative cleavage may be carried under conditions suitable to leave the protecting group intact. This may be followed by electrophilic removal of the protecting group (step (D)) with an electrophilic group as described above or nucleophilic removal of the protecting group with a base (e.g. CsF or K₃PO₄) to give unsymmetrical conjugated molecules.

Electrophilic ipso-degermylation advantageously leaves end functionality on the conjugated molecule which subsequently may be displaced by groups chosen to enhance the properties (e.g. electroactive properties) of the conjugated molecule. For example, the end functionality may be tailored to facilitate solution phase synthesis of block co-oligoheterocycles thereby giving greater versatility in preparing potentially useful electroactive materials.

Thus in a preferred embodiment, step (E) comprises:
(E1) ipso-degermylation using an electrophilic group E to release the bound conjugated molecule (P) having end functionality E;
   and the method further comprises:
(E) reacting the conjugated molecule (P) having end functionality E with a compound A′Y′ wherein group Y′ is capable of displacing end functionality E.

Preferably end functionality E is other than an end carboxyl (or a derivative (e.g. ester)) thereof. Particularly preferably the end functionality E is bromine, iodine or a boronic group such as boronic acid groups or derivatives thereof (e.g. ester derivatives thereof). Preferred are boronic acid groups of formula —B(OR)ₙ (as defined hereinafter), particularly preferably B(OH)₂.

Group Y′ may be an end capping group such as a linear or branched alkyl (e.g. C₁₋₆-alkyl), aryl, benzyl, vinyl, propargyl, allyl or alkynyl group or a conjugated molecule such as an oligoheterocydic group.

Preferably compound A′Y′ is a functionalised block conjugated polymer (or a functionalised block conjugated oligomer) wherein the block conjugated polymeric group Y′ is preferably a block of a conjugated molecule as hereinbefore defined. For example, group Y′ may be a dimeric, trimeric, tetrameric, pentameric or hexameric thiophene or pyridine block. Functionality A′ is typically bromine, iodine or a metallic for example a organometallic functionality such as an organoboron, organomagnesium, organozinc or organotin functionality. Preferred is a boronic functionality (e.g. an organoboron functionality —B(OR)ₙ as defined hereinafter), particularly preferably B(OH)₂. In this embodiment, step (D) may be carried out in the presence of a catalyst such as palladium or nickel.

It will be appreciated that this embodiment permits the synthesis of block conjugated molecules with a variety of precisely defined topologies. For example, it would be possible to synthesise a range of block conjugated co-oligomers such as PY′, PY′P, PY′P′(wherein P and Y′ are as hereinbefore defined and P′ which is different to P is a block of monomer units as hereinbefore defined).

The precise conditions for the ipso-degermylation of step (E) may be optimised by the skilled person to reflect its sensitivity to the electronic nature of the conjugated (e.g. heterocyclic) system. For example, electron rich heterocycles such as thiophene generally cleave most readily whereas electron deficient heterocycles such as pyridine require more forcing conditions. Moreover the conditions can be tailored to carry out step (D) before, after or simultaneous with step (E).

Step (B) may be carried out using a suitable coupling protocol. Many such protocols are established in the art and will be familiar to the skilled person (see inter alia Loewe at al, Adv. Mater. 1999, 11, 250-257). These include Suzuki, Kharasch (e.g. McCullough), Stille and Negishi type reactions, preferably Suzuki or Kharasch type reactions. Step (B) is typically carried out in the presence of a transition metal catalyst such as nickel or (preferably) palladium.

In a preferred embodiment, step (B) further comprises:
(B1) activating for example by halogenating the first monomer in a coupling position; and
(B2) reacting the product of step (B1) with the second monomer metallated in the coupling position.

This embodiment relies on the fact that the immobilised first monomer may be selectively halogenated in the coupling position without ipso-degermylative cleavage.

Prior to step (B1), the method may further comprise: (B0) lithiating the first monomer for example using nBuLi or lithium disopropylamide (LDA) in the coupling position.

Step (B1) may be carried out using bromine, iodine (e.g. in the presence of a mercury salt such as acetate or hexanoate) or (preferably) a milder source of iodonium ions. The source of iodinium ions is preferably 1,2-diiodoethane. Particularly preferably halogenation with 1,2-diiodoethane is carried out in reduced ambient light (e.g. in darkness). Particularly preferably halogenation is carried out with 1,2-diiodoethane in an amount at least one fold excess of the amount of lithiating agent (preferably LDA) used in step (B0).

In an alternative embodiment, step (B) comprises:
(B1′) metallating the first monomer in a coupling position; and
(B2′) reacting the product of step (B1′) with the second monomer halogenated in the coupling position.

The alternative embodiment relies on the fact that the immobilised first monomer may be selectively metallated (or transmetallated) in the coupling position without ipso degermylative cleavage. For example, the immobilised first monomer may be transmetallated using nBuLi and an organometallic transmetallating compound.

In a preferred alternative embodiment, step (B1′) comprises: (B1′a) lithiating the first monomer at the coupling position (for example in the presence of nBuLi) and (B1′b) transmetallating the first monomer at the coupling position. The first monomer is advantageously stable to strong bases such as nBuLi. For pyridine and thiophene, this generally leads to lithiation and transmetallation at the coupling position adjacent the heterocyclic atom.

The first or second monomer may be metallated (or transmetallated) at its coupling position with a metallic group e.g. an organometallic group. For example, the metallic group may be selected from organoboron, organomagnesium, organotin and organozinc groups. Preferred are organoboron groups such as boronic acid groups or derivatives thereof (e.g. ester derivatives thereof). Particularly preferably the organoboron group is of formula:
—B(OR)ₙ
(wherein: n is 2 or 3; and each R is independently hydrogen or an optionally substituted linear or branched C₁₋₆-alkyl group or two groups R represent an optionally substituted alkano bridging group between two oxygen atoms).

For the purposes of this specification we define boron as being a metal.

For example, two groups R may represent an optionally substituted ethano or propano bridging group between two oxygen atoms. Preferred is an ethano bridging group between two oxygen atoms which is preferably dialkyl (e.g. dimethyl) substituted at each carbon.

Preferred is a hypervalent boronate complex or a boronic ester group (or a hypervalent complex thereof). It is advantageous to use a weak base (e.g. NaHCO₃). Particularly preferred is a hypervalent boronate complex which advantageously does not require the addition of base (and therefore essentially does not remove any silyl protecting group). The hypervalent boronate complex may be a hypervalent alkyl boronate complex with a suitable metal counterion (e.g. Na or (preferably) Li). Preferred is the hypervalent ethyl boronate complex, particularly preferably in the absence of a base.

Certain of the hypervalent organoboron intermediates useful as first and/or second monomers in the method of the invention may lead to improved coupling and being novel are therefore patentably significant per se.

Viewed from a further aspect the present invention provides a compound of formula:
[X—B(OR)₃]M
wherein:
M is a counter ion;
X is an optionally ring substituted unsaturated monocyclic or polycyclic (e.g. a fused polycyclic) hydrocarbon or heterocyclic moiety; and
   each group R is independently hydrogen or an optionally substituted linear or branched C₁₋₆-alkyl group or two groups R represent an optionally substituted alkano bridging group between two oxygen atoms.

The group B(OR)₃ may include a pinacolato group. For example, two groups R may represent an optionally substituted ethano or propano bridging group between two oxygen atoms. Preferred is an ethano bridging group between two oxygen atoms which is preferably dialkyl (e.g. dimethyl) substituted at each carbon.

In a preferred embodiment, each R is the same and is a C₁₋₆-alkyl group. The hypervalent boronate complex of this embodiment advantageously does not require the addition of base (and therefore is not susceptible to removal of any silyl protecting group). Particularly preferred is the hypervalent ethyl boronate complex (ie R is ethyl).

Group X may be an optionally ring substituted heterocyclic moiety. The heterocyclic moiety may contain one, two or three heterocyclic atoms which may be the same or different. Preferably the (or each) heterocyclic atom is selected from the group consisting of nitrogen, sulphur, oxygen, phosphorous and selenium, preferably the group consisting of nitrogen, oxygen and sulphur, particularly preferably the group consisting of nitrogen and sulphur. Preferably the heterocyclic moiety may be a 5- or 6-membered optionally ring substituted heterocyclic moiety.

By way of example, the heterocyclic moiety may be selected from the group consisting of optionally ring substituted thiophene, furan, pyridine, imidazole, isothiazole, isooxazole, pyran, pyrazine, pyridazine, pyrazole, pyridine, pyrimidine, triazole, oxadiazole, pyrrole, indazole, indole, indolizine, pyrrolizine, quinazoline, quinoline and phenyl. Preferably the heterocyclic moiety is selected from the group consisting of optionally ring substituted thiophene and pyridine and particularly preferably is thiophene which may be substituted at the 3-position with an alkyl group (e.g. a C₁₋₈-alkyl such as a hexyl or octyl) or an aryl (e.g. a phenyl) group.

The counterion M may be a suitable metal counterion (e.g. Na or (preferably) Li).

The solid support may be any support compatible with the chosen parameters (e.g. solvent, temperature, reagents) and with chosen methods for monitoring the progress of the coupling reaction (e.g. IR or MAS NMR). Suitable solid supports may be surfaces, beads or fibres and will typically be polymeric including resins (preferably macroporous resins), tentagels or polystyrenes. The resins may be hydroxy functionalised (e.g. polyethyleneglycol based resins such as ARGOGEL™) or chloromethylated (e.g. chloromethylated polystyrene) to facilitate linking step (A).

In a preferred embodiment, step (A) comprises:
(A1) obtaining an immobilised germyl linking group on the solid support; and
(A2) linking the first monomer to the germanium of the immobilised germyl linking group.

The immobilised germyl linking group may be pre-prepared on the solid support or prepared in situ as desired. For example, an immobilised germyl linking group may be prepared from a solid support (e.g. resin) pre-functionalised with germanium. By way of example, a pre-prepared germane-containing styrenyl monomer may be copolymerised with styrene using a cross linker to give germanium functionalised polystyrene which may be straightforwardly activated for carrying out step (A2).

For step (A2), suitable reagents and conditions will be familiar to the skilled person and guidance may be found inter alia in Denat et al, Synthesis, 1992, 954-956 and Lukevics et al, J. Organomet. Chem., 1988, 20, 69-210.

The first monomer may be metallated (preferably lithiated) and reacted with the immobilised germyl linking grouping in step (A2). For this purpose, the immobilised germyl linking group has a suitable leaving group which is preferably chloride. The first monomer may be metallated in the chosen position (e.g. 2-, 3- or 2- and 5-positions of thiophene, pyrrole and furan and 2- or 3-positions of pyridine) whilst optionally protecting other positions. The chosen position may (for example) be metallated directly (e.g. lithiated directly using LDA) or by halogen-metal exchange of a halogen-substituted (e.g. bromo-substituted) first monomer (e.g. using n-BuLi). The germanium of the immobilised germyl linking group may be bound to an electronegative group to assist linking step (A2).

Alternatively the first monomer may be linked in step (A2) by cross-coupling. For this purpose, the first monomer may be halogenated. The first monomer may be halogenated in the chosen position (e.g. 2-, 3- or 2- and 5-positions; of thiophene, pyrrole and furan and 2- or 3-positions of pyridine) whilst optionally protecting other positions. Such a cross-coupling reaction is typically mediated by a Pd(0) catalyst in the presence of a mild base.

Step (A1) may comprise:
(A1′) immobilising an immunobilisable germyl linker on the solid support to form an immobilised germyl linking group;

Suitable immobilisable germyl linkers and methods for carrying out steps (A1), (A1′) and (A2) will generally be familiar to the skilled person and guidance may be found in inter alia Spivey et al, Chem Commun., 1999, 835-836 and Spivey et al, J. Org. Chem., 2000, 65, 5253-5263.

Typically the immobilisable germyl linker is derivable from GeCI₄ and may be of formula:
ZGeR₂X
wherein:
each group R which may be the same or different is an alkyl (such as methyl, ethyl, butyl or isopropyl), aryl, CF₃ or an electronegative group or precursor thereof;
X is H, a leaving group (such as OCOCF₃, OSO₃H or a halide (e.g. a chloride)) or a group MR′ₙ;
M is silicon, germanium, tin or boron;
R′ is alkyl (e.g. C₁₋₆-akyl), aryl or alkoxy (e.g. Cl₁₋₆-alkoxy); and
Z is an immobilising group.

Where X is H or a group MR′ₙ, the first monomer may be linked in step (A2) via a cross-coupling reaction. For this purpose, the first monomer may be halogenated and reacted with the immobilised germyl linking group. Preferably M is silicon, germanium or boron.

Preferably one group R is an electronegative group which advantageously improves the efficiency of subsequent germanium cleavage (such as germyl-Stille type cleavage) during linking step (A2). The electronegative group may be a non-carbon bound group such as an oxygen or nitrogen bound group or a halide. Preferably the electronegative group is an alkoxy or amino group. A preferred alkoxy group R is OR¹ (wherein R¹ is a C₁₋₆-alkyl). A preferred amino group R is NR²₂ (wherein R² is a C₁₋₆-alkyl).

Where one group R is a precursor to an electronegative group, step (A2) is preceded by:
(A0) converting the immobilisable germyl linker of formula ZGeR₂X into an immobilisable germyl linker of formula ZGeR₂X wherein one group R is an electronegative group.

This embodiment usefully permits a stable immobilisable germyl linker precursor to be converted into an immobilised germyl linking group which undergoes more efficient cleavage during step (A2). Step (A0) may be carried out oxidatively (e.g. by Germa-Polonovoski or Germa-Pummerer type reactions).

Immobilising group Z may be adapted to undergo Mitsunobu or Williamson type immobilisation to the solid support. Suitable immobilising groups Z include for example an etherifiable group such as a hydroxylated group (e.g. a terminal hydroxy containing group) for immobilisation on a suitably functionalised resin by etherification. For this purpose, the solid (e.g. polymeric) support is functionalised (e.g. hydroxyl or chloromethyl functionalised). The suitability of immobilising group Z and the immobilisation conditions may be conveniently predetermined in solution by a Mitsunobu reaction using for example ethoxyethanol or by a Williamson reaction using for example 2-chloroethylethanol.

A solid support particularly useful for carrying out a process according to the invention is of formula X(OR—GeR¹R² Hal)ₙ in which X is a high molecular weight material of low solubility in water and organic solvents, suitably a hydrocarbon resin substituted by alkoxy chains, for example polystyrene substituted by alkoxy, preferably propoxy or more preferably ethoxy or propoxy/ethoxy chains, R is a hydrocarbon group suitably having 1 to 12 and more preferably 3 to 10 carbon atoms, for example an alkyl, aryl group or arylalkyl group, the aryl group suitably comprising a benzene ring optionally substituted by alkyl groups, the Ge being preferably linked to an alkyl group, R¹ and R² individually being alkyl groups preferably having 1 to 6 carbon atoms and Hal representing a halide for example a bromide, iodide or preferably chloride atom and n being a large integer.

Protection/deprotection of the first monomer may facilitate the linking step (A). For example, a protecting group may be used to prevent unwanted lithiation at a specific position (e.g. the α-position) prior to step (A2). Although any suitable protecting group may be used, a trimethylsilyl, TMS, or tert. butyl dimethylsilyl, TBDMS, group is preferred and may be removed with familiar reagents such as a base e.g. K₃PO₄ or CsF prior to coupling step (B).

The invention thus provides a method for preparing a conjugated molecule comprising a first monomer coupled to a second monomer, said method comprising:
(i) linking the first monomer to a solid support via the germanium atom of a germyl linking group;
(ii) coupling the first monomer to the second monomer in a coupling position to form a bound conjugated molecule, wherein the second monomer has a protecting group in a non-coupling position;
(iii) optionally sequentially coupling a third, fourth . . . . and n^{th} monomer to the second, third and (n-1)^{th} monomer respectively;
(iv) removing the protecting group; and
(v) ipso-degermylation to release the bound conjugated molecule.

The present invention will now be described in a non-limitative sense with reference to the following Examples and the Figures in which:

FIG. 1 illustrates the resin/linkers adopted in the prior art by Fréchet 1 and Bäuerle 2;

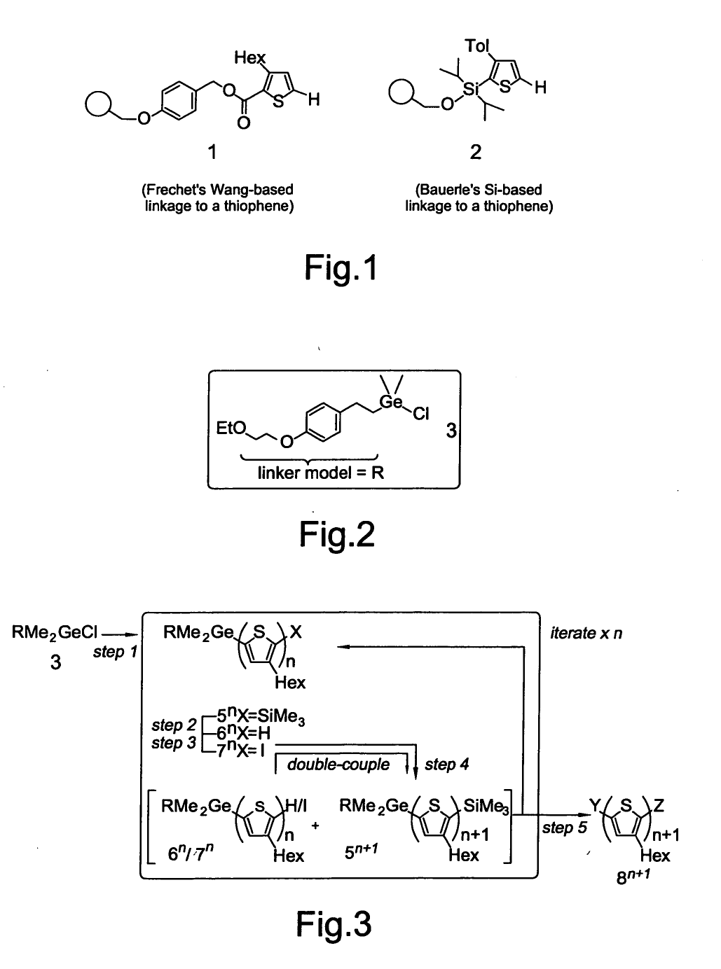

FIG. 2 illustrates the germyl linker 3 used in Example 1 relating to a solution phase model of a solid phase synthesis;

FIG. 3 illustrates the envisaged key steps in the iterative solid phase synthesis of an oligothiophene;

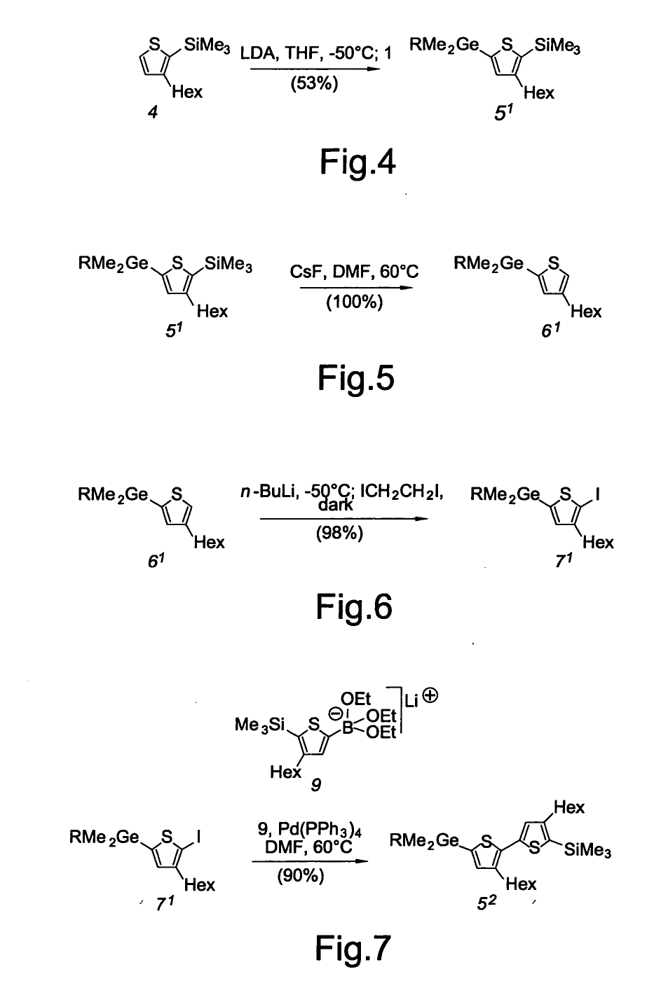

FIG. 4 illustrates linking of a protected thiophene monomer to the germyl linker (4 to 5¹);

FIG. 5 illustrates a proposed deprotection protocol (5¹ to 6¹);

FIG. 6 illustrates a proposed iodination protocol (6¹ to 7¹);

FIG. 7 illustrates a proposed coupling protocol (7¹ to 5²);

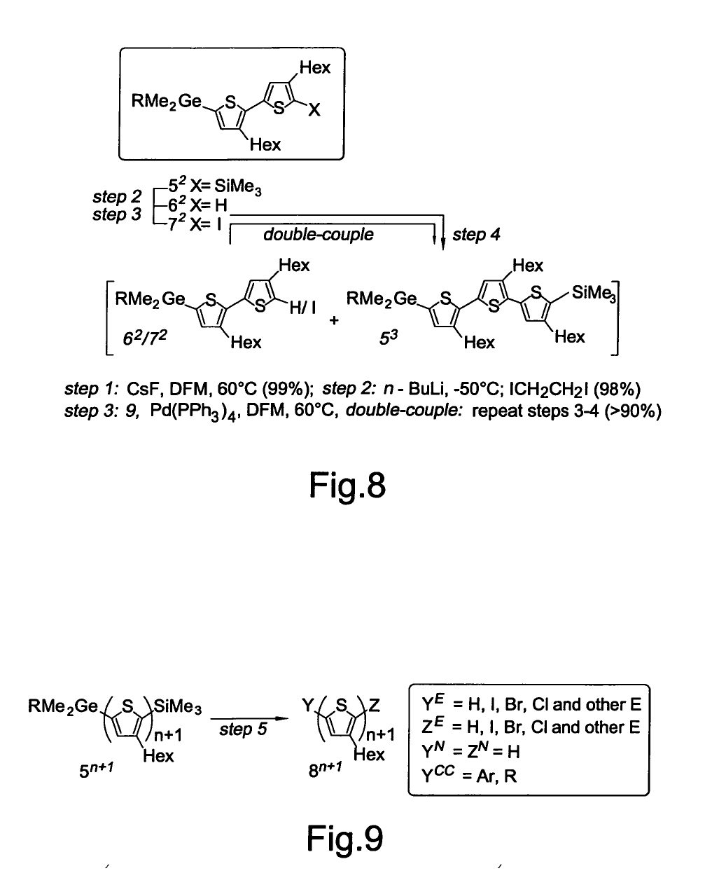

FIG. 8 illustrates a complete iterative cycle, including ‘double coupling’ (5² to 5³);

FIG. 9 illustrates potential products of cleavage protocols from the germyl linker (5ⁿ⁺1 to 8ⁿ⁺¹)

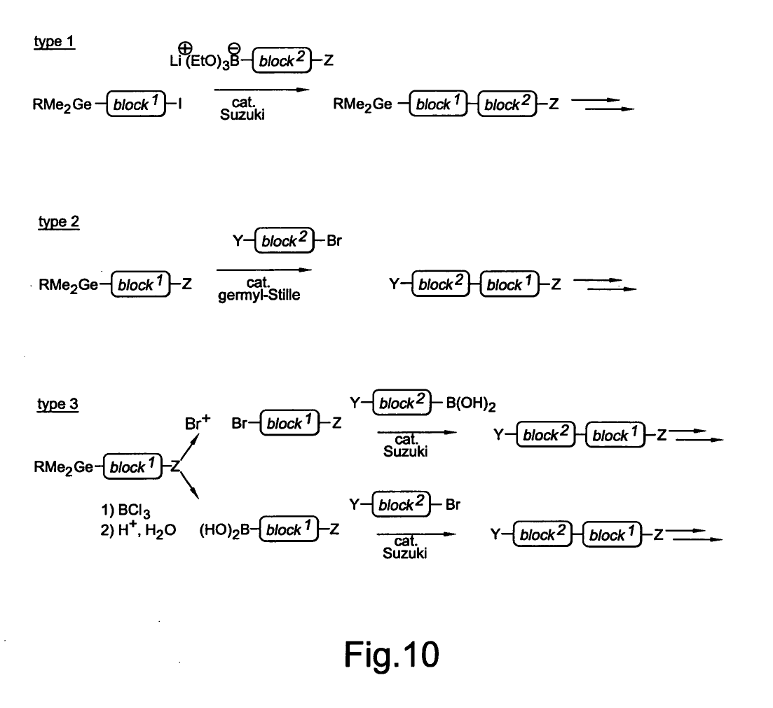

FIG. 10 illustrates schematically the preparation of block oligomers.

### EXAMPLE 1

Example 1 relates to a solution phase model of the solid phase synthesis of a high purity thiophene oligomer having well-defined regiochemistry using a germyl linker. Assembly of the oligomer is a stepwise process in which each monomer unit is added sequentially through repetitive transition metal mediated coupling to obtain highly pure and well-defined structures.

In order to compare materials obtained by the present method with conventional methods, it was decided to investigate the solution phase synthesis of hexylthiophene oligomers using a germyl linker 3 (see FIG. 2) as a model for a solid phase synthesis which is outlined in FIG. 3 and whose steps may be summarised as:
Step 1: attachment of the first TMS blocked monomer,
Step 2: to the cleavage of the TMS blocking group,
Step 3: conversion to an—iodide coupling precursor,
Step 4: cross-coupling of a second TMS blocked monomer,
Step 5: removal of the oligomer from the germanium-based linker.
   Steps 2, 3, and 4 represent the repetitive steps for the oligomer build-up. The role of the TMS group is to block the terminal-position of the iterated oligomer allowing steps 34 to be repeated in a double-coupling cycle so as to drive any unreacted iodide and any uniodinated/deiodinated material through to iterated product.
   Step 1: (FIG. 4)
   Thiophene 5¹ was prepared by transmetalation of linker model 3 with lithiated thiophene 4 in 53% yield. Here, the TMS protecting group ensures that none of the undesired alternate —lithiated thiophene is formed and moreover, in the context of SPS, would allow immobilization to be driven to completion by repeat transmetalation.
   Step 2: (FIG. 5)
   Cleavage of the TMS protecting group in thiophene 5¹ was achieved using CsF in DMF at 60° C. and gave germylthiophene 6¹ almost quantitatively with no detectable cleavage of the germyl linker.
   Step 3: (FIG. 6)
   —Iodination was achieved by the use of excess n-BuLi at −50° C. followed by treatment with excess 1,2-diiodoethane in the dark. Conversion of germylthiophene 6¹ to the corresponding iodothiophene 7¹ under these conditions was achieved in 98% yield.
   Step 4: (FIG. 7)
   Iodothiophene 7¹ was coupled using a novel ‘base-free’ Suzuki-type cross-coupling protocol to triethylborate salt 10. This salt is obtained as an easily handled white powder by direct evaporation of volatiles following lithiation/transmetalation of thiophene 4 with n-BuLi/B(OEt)₃ at −50° C. in THF. Using 5 mol % Pd(PPh₃)₄ in DMF at 60° C. in the absence of added base this salt cross-couples with iodothiophene 7¹ to give dithiophene 5² in 90% yield. No ipso-protodesilylation of the TMS group occurs under these conditions.
   Double-Coupling (Steps 3-4, Repeated):
   Successful double-coupling requires the TMS blocking group itself to be inert to step 3 and therefore sufficiently robust to enable iodination of any uncoupled and/or deiodinated material remaining following coupling. Analysis by ¹H NMR of the ‘crude’ reaction mixture following a cross-coupling between iodothiophene 7¹ and an excess of triethyborate salt 10 (FIG. 7) reveals, in addition to >90% cross-coupled product 5², small amounts of both unreacted iodothiophene 7¹ and deiodinated thiophene 6¹. Therefore, to validate the concept of double-coupling we subjected this material to a repeat-iodination/coupling cycle (steps 3-4) and re-examined the reaction mixture. Following this simulated double-coupling, by-products 7¹ and 6¹ can no longer be detected by ¹H NMR.
   A second iteration (n=2, steps 2-4, including simulated double-coupling) was also performed on dithiophene 5² yielding trithiophene 5³ with analogous results (FIG. 8).
   Step 5: (FIG. 9)

There are a number of options available for step 5 depending on the intended use of the cleaved oligomer. Protocols that result in the cleavage of both symmetrically end-functionalised and—telechelic oligomers with various useful end-functionality are possible.

Cleavage by an electrophile E⁺(e.g. H⁺, I⁺, Br⁺, Cl⁺, F⁺, NO⁺, NO₂⁺, SO₃⁺, RCO⁺, RSO₂⁺, BHal₂⁺(e.g. BCI₂⁺) or B(OH)₂⁺) results in electrophilic ipso-degermylation to introduce substituent Y^{E} leaving the TMS blocking group intact (Y=RMe₂Ge to Y=Y^{E}; Z=TMS). Under more forcing conditions both electrophilic ipso-degermylation and ipso-desilylation occurs giving symmetrically end-functionalised oligomer (Y=RMe₂Ge to Y=Y^{E} and Z=TMS to Z=Z^{E} where Y^{E}=Z^{E}). The use of two different electrophiles sequentially gives an—telechelic oligomer (8ⁿ⁺¹, Y=Y^{E} and Z=Z^{E} where Y^{E} Z^{E}). The use of an electrophile RCO⁺ in a Friedel-Crafts type ipso-degermylation is particularly attractive as subsequent reduction of the resulting ketone carbonyl to a methylene group (using for example LiAlH₄-AlCl₃) leaves an alkyl end-functionalised conjugated molecule. These are known to have favourable electronic properties (see for example Katz, Acc. Chem. Res., 2001, 45, 11).

Cleavage by a germyl-Stille type cross-coupling protocol introduces a C—C bond in place of the C—Ge bond leaving the TMS blocking group intact (Y=RMe₂Ge to Y=Y^{CC}; Z=TMS). Potential cross-coupling partners for this type of cleavage are substrates that can undergo oxidative insertion of Pd(0) to yield an active Pd(II) intermediate as in a standard Stille-type cross-coupling. These include aryl, heteroaryl₁ benzyl, allyl, propargyl, and alkynyl halides (e.g. I, Br, Cl), sulfonate esters (e.g. OSO₂CF₃, OSO₂CH₃, OSO₂p-Tol), and diazonium salts (N₂⁺). Cleavage in this fashion could be followed by electrophilic ipso-desilylayion as described above (Z=TMS to Z=Z^{E}) or by nucleophilic ipso-protodesilylation (cf step 2, e.g. FIG. 5) with a base (e.g. CsF, K₃PO₄) to introduce a hydrogen in place of the TMS blocking group (Z=TMS to Z=H).

Treatment with a base (e.g. CsF, K₃PO₄) to effect nucleophilic ipso protodesilylation (Z=TMS to Z=H) could also be performed prior to cleavage. Such cleavage by an electrophile E⁺, or by sequential use of two electrophiles, as described above, could again result in—telechelic or symmetrical oligomers by electrophilic ipso-degermylation without or with subsequent electrophilic substitution at the other terminus [(Y=RMe₂Ge to Y=Y^{E}; Z=H) or (Y=RMe₂Ge to Y=Y^{E} and Z=H to Z=Z^{E} where Y^{E} Z^{E} or Y^{E} Z^{E}]. Similarly, such cleavage by a Germyl-Stille type cross-coupling, as described above, could result in—telechelic oligomers (Y=RMe₂Ge to Y=Y^{CC}; Z=H) which could undergo subsequent electrophilic substitution at the other terminus (Z=H to Z=Z^{E}).

In this manner a wide range of usefully end-functionalised oligomers can be produced which may have useful electroactive properties in their own right and/or be valuable substrates for subsequent incorporation into more complex structures (e.g. block co-oligomers).

Preparation of Block Co-Oligomers (FIG. 10)

An oligoheterocyclic block prepared as described above is in an advantageous form for incorporation into a block co-oligomeric structure. Block coupling could be achieved by a number of possible protocols:

Type 1. by the coupling of oligoheterocyclic blocks in place of the single thiophene unit 9 by analogy with the iterative cyde;
Type 2. by direct germyl-Stille type cross coupling off the linker;
Type 3. by a Suzuki, Kharasch (e.g. McCullough) Stille, or Negishi,-type cross-coupling reaction between an appropriate halo-functionalised block and a metalated block in solution. Both types of coupling partner for this mode of block coupling can be prepared by appropriate electrophilic ipso-degermylation of oligoheterocyclic blocks prepared as described above.
   These generic possibilities are illustrated by way of example in FIG. 10.
   Experimental Procedures

All reactions were performed under anhydrous conditions and an atmosphere of nitrogen in flame-dried glassware. Yields refer to chromatographically and spectroscopically (¹H NMR) homogenous materials, unless otherwise indicated.

Solvents and reagents: All solvents were distilled before use. ‘Petrol’ refers to the fraction of light petroleum-ether boiling between 40-60° C. Commercial grade solvents used for flash chromatography were distilled before use. Anhydrous solvents were obtained as follows: DMF: Stirred over MgSO₄ under nitrogen for 24 h, distilled under reduced pressure, and stored over molecular sieves (4 Å) under nitrogen. MeNO₂: Distilled from CaH₂ under nitrogen immediately prior to use. THF and Et₂O: Distilled from sodium/benzophenone ketyl under nitrogen immediately prior to use. ‘Degassed’ refers to solutions that have been subjected to three successive freeze-thaw cycles on a nitrogen/high-vacuum line. All chemicals were handled in accordance with COSHH regulations. All reagents were used as commercially supplied. Chromatography: Flash chromatography was carried out using Merck Kiesegel 60 F₂₅₄ (230-400 mesh) silica gel. Only distilled solvents were used as eluents. Thin layer chromatography (TLC) was performed on Merck which were visualised either by quenching of ultraviolet fluorescence (λₘₐₓ, =254 nm) or by charring with 10% KMnO₄ in 1M H₂SO₄. Infra red spectra: These were recorded as thin films, nujol mulls, or as solutions in CHCl₃, on a Perkin-Elmer Paragon 1000 Fourier transform spectrometer. Only selected absorbencies (λₘₐₓ) are reported. ¹H NMR spectra: These were recorded at 250 MHz on a Bruker AM-250 instrument, and at 300 MHz and 400 MHz on Varian Inova-300 and 400 instruments respectively. Chemical shifts (8H) are quoted in parts per million (δ_{H}), referenced to the appropriate residual solvent peak. Coupling constants (J) are reported to the nearest Hz. ¹³C NMR spectra: These were recorded at 63 MHz on a Bruker AM-250 instrument, and at 100 MHz on a Varian Inova-300. Chemical shifts (° C.) are quoted in ppm, referenced to the appropriate solvent peak. Mass spectra: Low resolution mass spectra (m/z) were recorded on either a VG platform or VG prospec spectrometers, with only molecular ions (M⁺ or MH⁺), and major peaks being reported with intensities quoted as percentages of the base peak. High Resolution Mass Spectrometry (HRMS) measurements are valid to ±5 ppm.

### {2-[4-(2-Ethoxy-ethoxy)-phenyl]-ethyl}-dimethyl-germyl-chloride 3

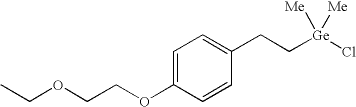 Tin(IV)chloride (1.50 mL, 12.8 mmol) was added drop-wise to a solution of {2-[4(2-ethoxy-ethoxy)phenyl]ethyl}-trimethyl-germane (421 mg, 1.4 mmol) in nitromethane (2 mL) at RT to give a pink solution. The reaction mixture was then heated at 50° C. for 16 h. Volatiles were then removed by distillation (90° C., 0.5 mmHg) to leave chlorodimethylgermane 3 as a brown oil (440 mg, 91%).); ¹H NMR (CDCl₃): δ 0.59 (s, 6H), 1.24 (t, J=7, 3H), 1.49 (t, J=8, 2H), 2.80 (t, J=8, 2H), 3.59 (q, J=7, 2H), 3.77 (t, J=5, 2H), 4.10 (t, J=6, 2H), 6.85 (d, J=8.5, 2H), 7.10 (d, J=8, 2H); MS (EI+) m/z 332 (M⁺). HRMS (EI+) calcd. for C₁₄H₂₃ClGe⁷⁴O₂ (M) 332.0598, found 332.0586.

### (3-Hexyl-thiophen-2-yl)-trimethyl-silane 4

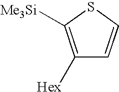 A solution of n-BuLi (0.787 mL, 2.2M, 1.73 mmol) in hexanes was added drop-wise to a degassed solution of 2-bromo-3-hexylthiophene¹ (387 mg, 1.57 mmol) in THF (3 mL) at −78° C. The mixture was stirred for 40 min at this temperature, and then trimethylchlorosilane (0.600 mL, 4.71 mmol) added drop-wise at −78° C. The resulting mixture was stirred for 1 hr at this temperature, warmed to RT and stirred for a further 1 hr. After quenching with sat. NH₄Cl (aq) (100 mL), the mixture was extracted with Et₂O (3×100 mL), the combined organic extracts dried (MgSO₄) and the solvent removed in vacuo. Purification by flash chromatography (pentane) gave silylthiophene 4 as a colourless oil (329 mg, 87%). R_{f} 0.85 (pentane); ¹H NMR (CDCl₃): δ 0.03 (s, 9H), 0.58 (t, J=6.5, 3H), 0.95-1.10 (m, 6H), 1.22-1.31 (m, 2H), 2.36 (t, J=8, 2H), 6.73 (d, J=4.5, 1H), 7.14 (d, J=4.5, 1H); MS (Cl⁺) m/z 240 (M⁺). HRMS (Cl⁺) calcd. for C₁₃H₂₄SiS (M) 240.1368, found 240.1361.

### [5-({2-[4-(2-Ethoxy-ethoxy)-phenyl]-ethyl}-dimethyl-germanyl)-3-hexyl-thiophen-2-yl)-trimethyl-silane 5¹

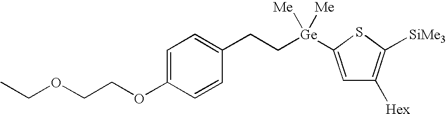 A solution of LDA (0.315 mL, 2.0M, 0.63 mmol) in hexanes/THF/ethylbenzene was added drop-wise to a degassed solution of silylthiophene 4 (144 mg, 0.60 mmol) in THF (2 mL) at −78° C. This solution was stirred for 40 min at this temperature, and then transferred by cannula to a degassed solution of chlorodimethylgermane 3 (100 mg, 0.30 mmol) in THF (1 mL) at −78° C. The resulting mixture was stirred for 1 hr at this temperature, warned to RT and stirred for a further 1 hr. After quenching with sat. NH₄Cl (aq) (50 mL), the mixture was extracted with Et₂O (3×50 mL), the combined organic extracts dried (MgSO₄) and the solvent removed in vacuo. Purification by flash chromatography (petro/EtOAc, 9/1) gave silylthiophenedimethylgermane 5¹ as a yellow oil (86.0 mg, 53%). R_{f} 0.61 (9/1, petrol/EtOAc); ¹H NMR (CDCl₃) δ 0.33 (s, 9H), 0.39 (s, 6H), 0.86 (t, J=7.5, 3H), 1.24 (t, J=7, 3H), 1.24-1.42 (m, 8H), 1.54-1.62 (m, 2H), 2.63-2.72 (m, 4H), 3.59 (q, J=7, 2H), 3.77 (t, J=5.5, 2H), 4.09 (t, J=6, 2H), 6.83 (d, J=8.5, 2H), 7.06 (s, 1H), 7.07 (d, J=8, 2H); ¹³C NMR (CDCl₃) δ-2.18 (2xq), 0.46 (3xq), 14.10 (q), 15.19 (q), 19.11 (t), 22.65 (t), 29.56 (t), 30.09 (t), 31.10 (t), 31.77 (t), 31.98 (t), 66.84 (t), 67.50 (t), 69.05 (t), 114.55 (2xd), 128.72 (2xd), 136.45 (d), 136.79 (s), 137.59 (s), 144.24 (s), 151.46 (s), 156.96 (s); IR (neat) 2928, 2858, 1688, 1611, 1584, 1511, 1246, 1125, 839 cm⁻¹; MS (EI+) m/z 536 (M⁺). HRMS (EI+) calcd. for C₂₇H₄₆O₂SiSGe⁷⁴ (M) 536.2200, found 536.2214.

### {2-[4-(2-Ethoxy-ethoxy)-phenyl]-ethyl}-(4-hexyl-thiophen-2-yl)-dimethyl-germane 6¹

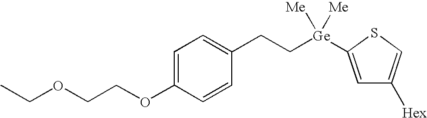 To TMS protected germylthiophene 51 (5.7 mg, 0.011 mmol) in DMF (1 mL) was added ceasium fluoride (8.1 mg, 0.053 mmol) and the mixture left to stir for 24 hrs at 60° C. The reaction mixture was partitioned between Et₂O (40 mL) and water (75 ml) and the Et₂O layer extracted with water (3×40 mL). The organic layer was dried (MgSO₄), the solvent removed in vacuo and the residue purified by flash chromatography (petrol/EtOAc, 9/1) to give germyldithiophene 6¹ as a brown oil (4.8 mg, 97%). R_{f} 0.38 (petrol/EtOAc, 9/1); ¹H NMR (CDCl₃): δ 0.38 (s, 6H), 0.88 (t, J=7, 3H), 1.23 (t, J=7, 3H), 1.25-1.30 (m, 8H), 1.54-1.62 (m, 2H), 2.62 (t, J=8, 2H), 2.67 (t, J=8.5, 2H), 3.59 (q, J=7, 2H), 3.77 (t, J=5.5, 2H), 4.09 (t, J=5.5, 2H), 6.83 (d, J=8, 2H), 6.96 (s, 1H), 7.06 (s, 1H), 7.11 (d, J=8, 2H); ¹³C NMR (CDCl₃) δ-2.29 (2xq), 14.12 (q), 15.19 (q), 19.10 (t), 22.63 (t), 29.16 (t), 30.09 (2xt), 30.67 (t), 31.71 (t), 66.84 (t), 67.52 (t), 69.05 (t), 114.57 (2xd), 124.51 (d), 128.72 (2xd), 134.51 (d), 136.75 (s), 139.57 (s), 144.48 (s), 156.96 (s); IR (neat) 2927, 2857, 1611, 1511, 1246, 1126 cm⁻¹; MS (EI+) m/z 464 (M⁺); HRMS (EI+) calcd. for C₂₄H₃₈Ge⁷⁴O₂S (M) 464.1804, found 464.1798.

### {2-[4-(2-Ethoxy-ethoxy)-phenyl]-ethyl}-(4-hexyl-5-iodo-thiophen-2-yl)dimethyl-germane 7¹

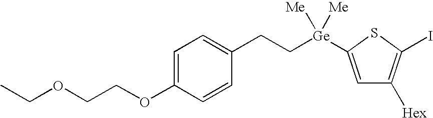 A solution of n-BuLi (2.21 mL, 1.5M, 3.30 mmol) in hexanes was added drop-wise to a degassed solution of germylthiophene 61 (512 mg, 1.10 mmol) in THF (3 mL) at −78° C. After stirring for 40 min at this temperature, a solution of degassed 1,2-diiodoethane (1.569, 5.52 mmol) in THF (2 mL) was added by cannula at −78° C. The resulting mixture was stirred in the dark for 1 hr at this temperature, warmed to RT and stirred for a further 1 hr. The reaction mixture was partitioned between sat. Na₂S₂O₃ (aq) (200 mL) and Et₂O (100 ml), extracted with Et₂O (2×100 mL), the organics combined and then dried (MgSO₄). The solvent was removed in vacuo and the residue purification by flash chromatography (petrol/EtOAc, 9/1) to give germylthiopheneiodide 7¹ as a yellow oil (632 mg, 98%). R_{f} 0.41 (petrol/EtOAc, 9/1); ¹H NMR (CDCl₃): δ 0.37 (s, 6H), 0.88 (t, J=6.5, 3H), 1.23 (t, J=7, 3H), 1.25-1.31 (m, 8H), 1.53-1.56 (m, 2H), 2.53 (t, J=8, 2H), 2.66 (t, J=8, 2H), 3.59 (q, J=7, 2H), 3.77 (t, J=5.5, 2H), 4.09 (t, J=6, 2H), 6.75 (s, 1H), 6.83 (d, J=8.5, 2H), 7.07 (d, J=8, 2H); ¹³C NMR (CDCl₃) δ-2.30 (2xq), 14.13 (q), 15.20 (q), 19.06 (t), 22.63 (t), 29.05 (t), 30.02 (t), 30.14 (t), 31.65 (t), 31.91 (t), 66.85 (t), 67.51 (t), 69.05 (t), 77.91 (s), 114.58 (2xd), 128.73 (2xd), 133.86 (d), 136.41 (s), 145.61 (s), 148.17 (s), 157.02 (s); IR (neat) 2928, 2856, 1611, 1584, 1510, 1455, 1246, 1125 cm⁻¹; MS (EI+) m/z 590 (M⁺). HRMS (ES+) calcd. for C₂₄H₃₈O₂SGe⁷⁴ (MH) 591.0849, found 591.0870.

### 2-(4-Hexyl-5-trimethylsilanyl-thiophen-2-yl)-4,4,5,5-tetramethyl-[1,3,2]dioxaborolane 8

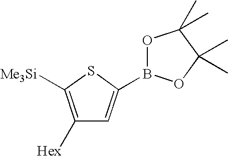 A solution of LDA (0.690 mL, 2.0M, 1.38 mmol) in hexanes/ethylbenzene/THF was added drop-wise to a degassed solution of TMS thiophene 4 (166 mg, 0.69 mmol) in THF (2 mL) at −50° C. After stirring for 40 min at this temperature, a degassed solution of 2-isopropoxy-4,4,5,5-tetramethyl-[1,3,2]dioxaborolane (334 mg, 1.79 mmol) in THF (2 mL) was added by cannula at −78° C. The resulting mixture Was stirred for 30 min at this temperature, warmed to RT and stirred for a further 15 min. The reaction mixture was cooled to 0° C. and anhydrous HCl in Et₂O (1.79 ml, 1.0M, 1.79 mmol) added. The mixture was left to stir at this temperature for 15 min and then allowed to warm to RT. The solvent was removed in vacuo and the residue taken up in dry Et₂O. The solution was passed through a pad of dry celite, dried (MgSO₄) and the solvent removed in vacuo. The residue was purified by flash chromatography (petro/EtOAc, 19/1) to give thiophene pinacolato boronic ester as a courless oil (131 mg, 52%). ¹H NMR (CDCl₃): δ 0.03 (s, 9H), 0.58 (t, J=7, 3H), 0.94-1.02 (m, 6H), 1.03 (s, 12H), 1.27 (m, 2H), 2.36 (t, J=8, 2H), 7.26 (s, 1H). ¹³C NMR (CDCl₃) δ 0.23 (3xq), 14.07 (q), 22.58 (t), 24.74 (4xq), 29.43 (t), 31.00 (t), 31.76 (2xt), 83.97 (2xs), 140.01 (d), 141.46 (s), 151.64 (s) (absent: SCB); MS (EI+) m/z 367 (M⁺).

### (4-Hexyl-5-trimethylsilanyl-thiophen-2-yl)-triethylborate Lithium Salt 9

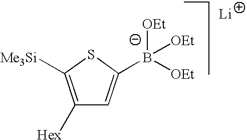 A solution of n-BuLi (0.298 mL, 1.5M, 0.45 mmol) in hexanes was added drop-wise to a solution of silylthiophene 4 (97.6 mg, 0.41 mmol) in THF (2 mL) at −50° C. and stirred for 40 min at this temperature. To this was added triethylborate (0.207 mL, 1.22 mmol) drop-wise at −50° C. The resulting mixture was stirred for 1 hr at this temperature, warmed to RT and stirred for a further 30 min. The solvent was then removed in vacuo to give the triethylborate lithium salt 9 as a white powder. mp 95-98° C.; ¹H NMR (CDCl₃): δ 0.33 (s, 9H), 0.88 (t, J=6.5, 3H), 1.17-1.58 (m, 17H), 2.66 (t, 2H), 4.14 (q, J=7, 6H), 7.46 (s, 1H).

### [5′-({2-[4-(2-Ethoxy-ethoxy)-phenyl]-ethyl}-dimethyl-germanyl)-4,3′-dihexyl-[2,2]bithiophenyl-5-yl]-trimethyl-silane 5²

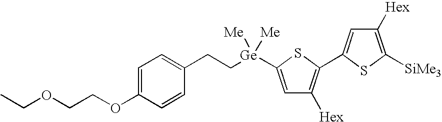 To a degassed solution of triethylborate salt 9 (63.0 mg, 0.101 mmol) and germylthiopheneiodide 7¹ (30.0 mg, 0.051 mmol) in THF (1 mL) at −78° C. was added Pd(PPh₃)₄ (6.0 mg, 0.0051 mmol) and the resulting mixture stirred at 60° C. for 24 hr. The reaction mixture was partitioned between water (100 mL) and Et₂O (50 ml), extracted with Et₂O (2×50 mL) and the organics combined and dried (MgSO₄). The solvent was removed in vacuo and the residue purification by flash chromatography (petrol/EtOAc, 9/1) to give silyl protected germyldithiophene 5² as a yellow oil (29.0 mg, 90%). R_{f} 0.50 (petro/EtOAc, 9/1); ¹H NMR (CDCl₃): δ 0.05 (s, 9H), 0.10 (s, 6H), 0.53-0.62 (m, 6H), 0.94 (t, J=7, 3H), 0.94-1.08 (m, 14H), 1.28-1.34 (m, 4H), 2.30-2.48 (m, 6H), 3.30 (q, J=7, 2H), 3.47 (t, J=4.5, 2H), 3.79 (t, J=4.5, 2H), 6.54 (d, J=8.5, 2H), 6.63 (s, 1H), 6.74 (s, 1H), 7.80 (d, J=8.5, 2H). ¹³C NMR (400 MHz, CDCl₃) δ-2.34 (2xq), 0.43 (3xq), 14.08 (2xq), 15.16 (q), 19.08 (t), 22.62 (2xt), 29.20 (t), 29.31 (t) 29.39, (t), 30.07 (t), 30.70 (t), 31.48 (t), 31.64 (t), 31.70 (t), 31.77 (t), 66.82 (t), 67.53 (t), 69.03 (t), 114.58 (2xd), 128.73 (2xd), 128.79 (d), 132.61 (s), 135.63 (s), 136.11 (d), 136.67 (s), 137.97 (s), 140.19 (s), 140.34 (s), 150.68 (s), 156.97 (s); IR (neat) 2956, 2928, 2858, 1732, 1611, 1584, 1511, 1236 cm⁻¹; MS (EI+) m/z 702 (M⁺). HRMS (ES+) calcd. for C₃₇H₆₁O₂SiS₂Ge⁷⁴ (MH) 703.3094, found 703.3089.

### (3,4′-Dihexyl-[2,2′]bithlophenyl-5-yl)-{2-[4-(2-ethoxy-ethoxy)-phenyl]-ethyl}-dimethyl germane 6²

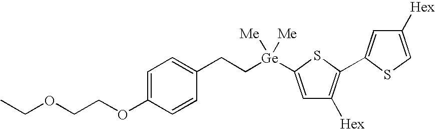 To TMS protected germyldithiophene 5² (60.0 mg, 0.086 mmol) in DMF (1 mL) was added ceasium fluoride (63.4 mg, 0.42 mmol) and the mixture left to stir for 24 hrs at 60° C. The reaction mixture was partitioned between Et₂O (50 mL) and water (100 ml) and the Et₂O layer extracted with water (3×50 mL). The organic layer was dried (MgSO₄), the solvent removed in vacuo and the residue purified by flash chromatography (petrol/EtOAc, 9/1) to give germyldithiophene 6² as a brown oil (54.0 mg, 99%). R_{f} 0.40 (9/1, petrol/EtOAc); ¹H NMR (CDCl₃): δ 0.40 (s, 6H), 0.85-0.90 (m, 6H), 1.23 (t, J=7H, 3H), 1.20-1.33 (m, 14H), 1.56-1.62 (m, 4H), 2.59 (t, J=7.5, 2H), 2.66-2.76 (m, 4H), 3.59 (q, J=7, 2H), 3.77 (t, J=4.5, 2H), 4.09 (t, J=5, 2H), 6.83 (d, J=8.5, 2H), 6.86 (s, 1H), 6.92 (s, 2H), 7.08 (d, J=8.5, 2H); ¹³C NMR (400 MHz, CDCl₃) δ-2.32 (2xq), 14.13 (2xq), 15.20 (q), 19.07 (t), 22.65 (2xt), 29.03 (t), 29.18 (t), 29.37 (t), 30.08 (t), 30.41 (t), 30.54 (t), 30.80 (t), 31.68 (2xt), 66.85 (t), 67.49 (t), 69.05 (t), 114.55 (2xd), 119.71 (d), 126.93 (d), 128.74 (2xd), 135.61 (s), 136.09 (d), 136.65 (s), 138.06 (s), 140.35 (2xs), 143.53 (s), 156.97 (s); IR (neat) 2927, 2857, 1728, 1611, 1510, 1457, 1246, 1125 cm⁻¹; MS (EI+) m/z 630 (M⁺). HRMS (Cl⁺) calcd. for C₃₄H₅₂O₂S₂Ge⁷⁴ (M) 630.2621, found 630.2642.

### (3,4′-Dihexyl-5′-iodo-[2,2′]bithiophenyl-5-yl)-{2-[4-(2-ethoxy-ethoxy)-phenyl]-ethyl}-dimethyl Germane 7²

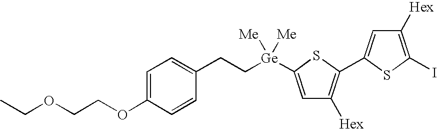 A solution of n-BuLi (0.060 mL, 2.5M, 0.149 mmol) in hexanes was added drop-wise to a degassed solution of germyldithiophene 6² (19.0 mg, 0.030 mmol) in THF (1 mL) at −78° C. After stirring for 40 min at this temperature, a degassed solution of 1,2-diiodoethane (67.2 mg, 0.238 mmol) in THF (1 mL) was added by cannula at −78° C. The resulting mixture was stirred in the dark for 1 hr at this temperature, warmed to RT and stirred for a further 1 hr. The reaction mixture was partitioned between sat. Na₂S₂O₃ (aq) (50 mL) and Et₂O (50 ml), extracted with Et₂O (2×50 mL), the organics combined and then dried (MgSO₄). The solvent was removed in vacuo and the residue purification by flash chromatography (petrol/EtOAc, 9/1) to give germyldithiopheneiodide 7² as a yellow oil (23.1 mg, 98%). R_{f} 0.42 (9/1, petrol/EtOAc); ¹H NMR (CDCl₃): δ 0.33 (s, 6H), 0.78-0.85 (m, 6H), 1.17 (t, J=7H, 3H), 1.17-1.27 (m, 14H), 1.50-1.54 (m, 4H), 2.46 (t, J=7.5, 2H), 2.58-2.67(m, 4H), 3.53 (q, J=7, 2H), 3.71 (t, J=5, 2H), 4.03 (t, J=5, 2H), 6.68 (s, 1H), 6.77 (d, J=8.5, 1H), 6.85 (s, 1H), 7.02 (d, J=8.5, 2H); ¹³C NMR (400 MHz, CDCl₃) δ-2.43 (2xq), 14.10 (q), 14.20 (q), 15.17 (q), 19.03 (t), 22.62 (2xt), 28.90 (t), 29.15 (t), 29.31 (t), 29.95 (t), 30.05 (t), 30.76 (t), 31.65 (2xt), 32.35 (t), 66.84 (t), 67.48 (t), 69.03 (t), 73.63 (q), 114.55 (2xd), 126.20 (d), 128.72 (2xd), 135.57 (s), 136.04 (d), 136.53 (s), 138.81 (s), 140.90 (s), 141.06 (s), 147.48 (s), 156.98 (s); IR (neat) 2928, 2857, 1728, 1611, 1511, 1455, 1125 cm⁻¹; MS (EI+) m/z 756 (M⁺). HRMS (EI+) calcd. for C₃₄H₅₁O₂S₂ Ge⁷⁴I (M) 756.1587, found 756.1571.

### [5″({2-[4-(2-Ethoxy-ethoxy)-phenyl]-ethyl}-dimethyl-germanyl)-4,3′,3″-trihexyl-[2,2′;5′2″]terthiophen-5-yl]-trimethyl-silane 5³

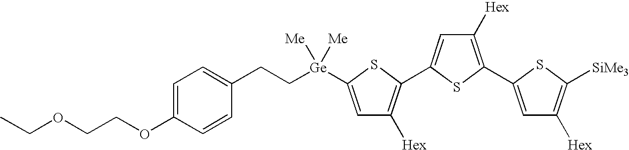 To a degassed solution of triethylborate salt 9 (118 mg, 0.30 mmol) and germyldithiopheneiodide 7² (29.7 mg, 0.039 mmol) in THF (1 mL) at −78° C. was added Pd(PPh₃)₄ (6.0 mg, 0.0051 mmol) and the resulting mixture stirred at 60° C. for 24 hr. The reaction mixture was partitioned between water (100 mL) and Et₂O (50 ml), extracted with Et₂O (2×50 mL) and the organics combined and dried (MgSO₄). The solvent was removed in vacuo and the residue purification by flash chromatography (petro/EtOAc, 9/1) to give silyl protected germyltrithiophene 5³ as a yellow oil (31.6 mg, 93%). R_{f} 0.52 (petrol/EtOAc, 9/1); ¹H NMR (CDCl₃): δ 0.25 (s, 9H), 0.31 (s, 6H), 0.75-0.83 (m, 9H), 1.14 (t, J=7, 3H), 1.19-1.25 (m, 20H), 1.47-1.55 (m, 6H), 2.50-2.70 (m, 8H), 3.50 (q, J=6.5, 2H), 3.68 (1, J=5, 2H), 4.00 (t, J=5, 2H), 6.74 (d, J=9, 2H), 6.82 (s, 1H), 6.83 (s, 1H), 6.96(s, 1H), 7.00 (d, J=9, 2H); IR (neat) 2928, 2858, 1729, 1611, 1584, 1511, 1456, 1248, 839 cm⁻¹; MS (ES+) m/z 869 (MH⁺). HRMS (ES+) calcd. for C₄₇H₇₄O₃S₂Ge⁷⁴I (MH) 869.3910, found 869.3901.

### tert-Butyl-(4-hexyl-thophen-2-yl)-dimethyl-silane 10

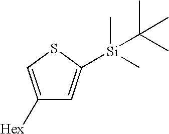 A solution of LDA (3.12 mL, 2.0M, 6.24 mmol) in hexanes/ethylbenzene/THF was added drop-wise to a degassed solution of 3-hexyl-thiophene (1.00 g, 5.94 mmol) in THF (10 mL) at −50° C. to give an orange solution. After stirring for 40 min at this temperature, a degassed solution of tert-butyldimethylsilyl chloride (1.34 g, 0.89 mmol) in THF (5 mL) was added by cannula at −50° C. The resulting mixture was warmed to −40° C., stirred for 30 min at this temperature, warmed to RT and stirred for a further 40 min to give a yellow solution. After quenching with sat. NH₄Cl (aq) (50 mL), the mixture was extracted with Et₂O (3×50 mL), the combined organic extracts dried (MgSO₄) and the solvent removed in vacuo. Purification was initially by vacuum distillation (105° C., 10⁻³ Torr) to remove starting material and then by reverse phase HPLC (MeOH/H₂O, 19/1) to give silylthiophene 10 as a colorless oil (1.05 g, 63%). ¹H NMR (CDCl₃): δ 0.27 (s, 6H), 0.87 (t, J=7.5, 3H), 0.90 (s, 9H), 1.24-1.30 (m, 6H), 1.61 (t, J=8, 2H), 2.62 (t, J=8, 2H), 7.15 (s, 1H), 7.25 (s, 1H); ¹³C NMR (CDCl₃) δ-4.88 (2xq), 14.16 (q), 16.87 (s), 22.67 (t), 26.39 (3xq), 29.14 (t), 30.02 (t), 30.70 (t), 31.73 (t), 125.42 (d), 136.63 (d), 136.91 (s), 144.47 (s); IR (neat) 2953, 2925, 2855, 1462, 1406, 1361, 1249, 1198, 1008, 938, 832 cm⁻¹; MS (EI+) m/z 282 (M⁺); HRMS (EI+) calcd. for C₁₆H₃₀SSi (M) 282.1838, found 282.1827; Anal. calcd. for C₁₆H₃₀SSi: C 68.01, H 10.70, S 11.35, found C 68.45, H 11.04, S 11.45; HPLC purity 100.0%.

### 2-[5-(tert-Butyldimethyl-silanyl)-3-hexyl-thiophen-2-yl]-4,4,5,5-tetramethyl-[1,2,3]dioxaboralane 11

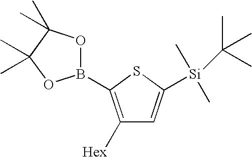 A solution of LDA (1.33 mL, 2.0M, 2.66 mmol) in hexanes/ethylbenzene/THF was added drop-wise to a solution of silylthiophene 10 (501 mg, 1.77 mmol) in THF (5 mL) at −50° C. and then warmed to −40° C. give an orange solution. After stirring for 40 min at this temperature the reaction was cooled to −50° C. and a solution of 2-isopropoxy-4,4,5,5-tetramethyl-[1,3,2]dioxaborolane (162 mg, 0.87 mmol) in THF (1 mL) (×3) was added drop-wise by cannula. The resulting mixture was stirred for 30 min at 40° C., warmed to room temperature and stirred for a further 15 min. The reaction was then cooled to 0° C. and anhydrous HCl (0.71 ml, 1.0M, 0.71 mmol) in ether added. The mixture was left to stir at this temperature for 15 min and then allowed to warm to RT. The solvent was removed in vacuo and the residue taken up in dry Et₂O. The solution was passed through a pad of dry celite, dried (MgSO₄) and the solvent removed in vacuo. The residue was purified by flash chromatography (petro/DCM, 3/1) to give silylthiophene pinacolato-boronic ester 11 as a pale yellow oil (371 mg, 51%). R_{f} 0.40 (3:1, petrol/DCM); ¹H NMR (CDCl₃): δ 0.26 (s, 6H), 0.87 (t, J=7, 3H), 0.90 (s, 9H), 1.27-1.32 (m, 18H), 1.57 (t, J=8, 2H), 2.87 (t, J=8, 2H), 7.12 (s, 1H); ¹³C NMR (CDCl₃) δ 4.83 (2xq), 14.17 (q), 16.86 (s), 22.67 (t), 24.86 (4xq), 26.44 (3xq), 29.08 (t), 29.98 (t), 31.72 (t), 32.02 (t), 83. 44 (s), 138.38 (d), 144.89 (s), 155.32 (s), (absent: SCB); IR (neat) 2955, 2927, 2857, 1525, 1470, 1435, 1370, 1332, 1298, 1271, 1250, 1214, 1166, 1144, 1047, 1008 cm⁻¹; MS (ES+) m/z 409 (MH); HRMS (ES+) calcd. for C₂₂H₄₂BO₂SSi (MH) 409.2768, found 409.2770.

### 4{2-[Dichloro-4methoxy-phenyl)germanyl]-ethyl}-phenol 12

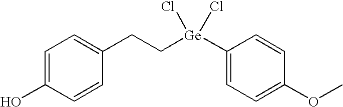 To magnesium (1.01 g, 42 mmol) in THF (25 ml) was added 4-bromoanisole (5.21 ml, 42 mmol) and the mixture was heated briefly to initiate Grignard formation. After stirring for 1 hr the grey solution was added drop-wise to a solution of germyl chloride (1.25 g, 4.2 mmol) in THF at RT. The yellow reaction mixture was then left stirring at this temperature for 16 hrs before quenching dropwise with water until no effervescence occurs. The solvent was the removed in vacuo and the residue taken up in DCM (30 ml). To the solution was added 1N HCl (5 ml) with stirring and then conc. HCl (60 ml). The resultant mixture was stirred vigorously for 40 min before extracting the HCl layer with DCM (3×50 mL), the combined organic extracts dried (MgSO₄) and the solvent removed in vacuo. The residue was taken up in DCM (50 ml) and 0.5M NaOH (aq) (100 ml) and the aqueous layer extracted with DCM (3×50 mL). To the aqueous layer was then added 1N HCl (15 ml) with shaking and then conc. HCl (100 ml). The aqueous layer was then extracted with DCM (3×100 mL), the combined organic extracts dried (MgSO₄) and the solvent removed in vacuo to give 12 as an orange/brown oil (1.25 g, 84%). ¹H NMR (CDCl₃): δ 1.96-2.02 (m, 2H), 2.83-2.90 (m, 2H), 3.75 (s, 3H), 4.84 (s, 1H), 6.65 (d, J=8.5, 2H), 6.88 (d, J=9, 2H), 6.99 (d, J=8.5, 2H), 7.40 (d, J=9, 2H); ¹³C NMR (CDCl₃) δ 27.81 (t), 28.55 (t), 55.39 (q), 114.58 (2xd), 115.51 (2xd), 126.72 (s), 129.35 (2xd), 133.76 (2xd, s), 154.07 (s), 162.12 (s); IR (neat) 3019, 2931, 2839, 2361, 1591, 1514, 1442, 1403, 1290, 1254 cm⁻¹; MS (EI+) m/z 372 (M⁺); HRMS calcd. for C₁₅H₁₆Cl₂Ge⁷⁴O₂ (M) 371.9739, found 371.9749.

### 4-{2-[(4-Methoxy-phenyl)-dimethyl-germanyl]-ethyl}-phenol 13

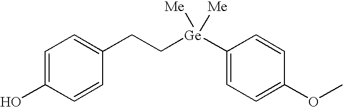 A solution of MeMgBr (1.0 mL, 3.0M, 3.03 mmol) in Et₂O was added to a solution of dichlorogermane 12 (184 mg, 0.49 mmol) in THF (3 mL). The mixture was then refluxed at 110° C. for 16h before partitioning between sat. NH₄Cl (aq) (100 mL) and Et₂O (100 mL). After extracting further with Et₂O (2×100 mL) the combined organic extracts were dried (MgSO₄) and concentrated in vacuo. Purification by flash chromatography (petrol/EtOAc, 3/1) gave dimethylgermane 13 as a pale yellow oil (125 mg, 74%). R_{f} 0.4 (petro/EtOAc, 3/1); ¹H NMR (CDCl₃): δ 0.25 (s, 6H); 1.11-1.18 (m, 2H), 2.51-2.57 (m, 2H), 3.73 (s, 3H), 4.67 (s, 1H), 6.64 (d, J=8.5, 2H), 6.84 (d, J=9, 2H), 6.95 (d, J=8.5, 2H), 7.29 (d, J=9, 2H); ¹³C NMR (CDCl₃) δ-3.56 (2xq), 18.21 (t), 30.22 (t), 55.13 (q), 113.84 (2xd), 115.14 (2xd), 128.94 (2xd), 132.15 (s), 134.48 (2xd), 137.01 (s), 153.45 (s), 159.85 (s); IR (neat) 3401 (broad), 3020, 2931, 2905, 2838, 1612, 1592, 1569, 1513, 1500, 1462, 1443, 1358, 1279, 1246, 1181, 1093 cm⁻¹; MS (EI+) m/z 332 (M⁺); HRMS calcd. for C₁₇H₂₂Ge⁷⁴O₂ (M) 332.0832, found 332.0824.

### {2-[4-(2-Ethoxy-ethoxy)-phenyl]-ethyl}-(4-methoxy-phenyl)-dimethyl-germane 14

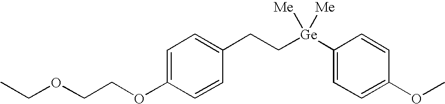 To a solution of dimethylgermane 13 (96.1 mg, 0.29 mmol) in acetonitrile (1 ml) was added 2-chlorodiethyl ether (0.070 mL, 0.64 mmol), tetra-n-butylammonium iodide (10.7 mg, 0.03 mmol) and cesium carbonate (153 mg, 0.44 mmol). The mixture was refluxed at 85° C. for 17 h then cooled and filtered. The solvent was removed in vacuo and the residue purified by flash chromatography (petrol/EtOAc, 9/1) to give the title compound 14 as a pale yellow oil (106 mg, 90%). R_{f} 0.3 (petrol/EtOAc, 9/1); ¹H NMR (CDCl₃): δ 0.25 (s, 6H); 1.12-1.19 (m, 5H), 2.52-2.56 (m, 2H), 3.52 (q, J=7, 2H), 3.70 (t, J=4.5, 2H), 3.73 (s, 3H), 4.01 (t, J=4.5, 2H), 6.64 (d, J=8.5, 2H), 6.84 (d, J=10.5, 2H), 6.95 (d, J=9, 2H), 7.29 (d, J=9, 2H); ¹³C NMR (CDCl₃) 8-3.53 (2xq), 15.23 (q), 18.19 (t), 30.24 (t), 55.06 (q), 66.86 (t), 67.53(t), 69.08 (t), 113.81 (2xd), 114.55 (2xd), 128.71 (2×/d), 132.03 (s), 134.47 (2xd), 137.06 (s), 156.93 (s), 159.94 (s); IR (neat) 2930, 2871, 1611, 1593, 1568, 1511, 1500, 1458, 1280, 1247, 1181, 1125 cm⁻¹; MS (EI+) m/z 404 (M⁺); HRMS calcd. for C₂₁H₃₀Ge⁷⁴O₃ (M) 404.1407, found 404.1393.

### 4-{2-[(4-Methoxy-phenyl)-di-p-tolyl-germanyl]-ethyl}-phenol 15

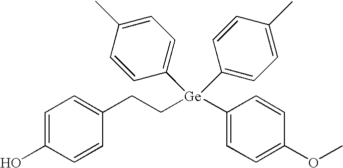 To oven dried Mg (120 mg, 5.00 mmol) in THF (3 ml) was added 4-bromotoluene (855 mg, 5.00 mmol) drop-wise. Grignard formation was initiated by heating and after the magnesium had disappeared it was added to a solution of dichlorogermane 12 (186 mg, 0.50 mmol) in THF (3 mL). The mixture was then refluxed at 110° C. for 16 h before partitioning between sat. NH₄Cl (aq) (100 mL) and Et₂O (100 mL). After extracting further with Et₂O (2×100 mL) the combined organic extracts were dried (MgSO₄) and concentrated in vacuo. Purification by flash chromatography (petrol/EtOAc, 3/1) gave ditolylgermane 15 as a yellow oil (280 mg, 92%). R, 0.4 (petrol/EtOAc, 3/1); ¹H NMR (CDCl₃): δ 1.72-1.80 (m, 2H), 2.36 (s, 6H), 2.70-2.77 (m, 2H), 3.81 (s, 3H), 4.64 (s, 1H), 6.71 (d, J=8.5, 2H), 6.92 (d, J=8.5, 2H), 7.04 (d, J=8.5, 2H), 7.19 (d, J=8, 4H), 7.38 (d, J=8, 4H), 7.40 (d, J=8.5, 2H); ¹³C NMR (CDCl₃) δ16.63 (t), 21.58 (2xq), 30.43 (t), 55.19 (q), 114.17 (2xd), 115.31 (2xd), 128.18 (s), 129.03 (2xd), 129.19 (4xd), 133.79 (2xs), 135.02 (4xd), 136.33 (2xd), 137.14 (s), 138.77 (2xs), 153.62 (s), 160.31 (s); IR (neat) 3409 (broad), 3012, 2921, 2861, 1593, 1568, 1512, 1442, 1392, 1281, 1247, 1180, 1089, 1031 cm⁻¹; MS (EI+) m/z 484 (M⁺); HRMS (EI+) calcd. for C₂₉H₃₀Ge⁷⁴O₂ (M⁺) 484.1458, found 484.1446.

### {2-[4-(2-Ethoxy-ethoxy)-phenyl]-ethyl}-(4-methoxy-phenyl)-di-p-tolyl-germane 16

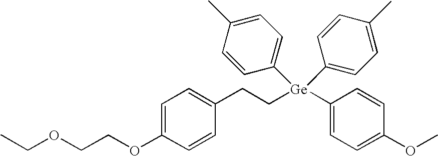 To a solution of ditolylgermane 15 (9.57 g, 20.0 mmol) in acetonitrile (40 ml) was added 2-chlorodiethyl ether (4.56 mL, 41.5 mmol), tetra-n-butylammonium iodide (739 mg, 2.0 mmol) and cesium carbonate (14.1 g, 40.0 mmol). The mixture was refluxed at 85° C. for 17 h then cooled and filtered. The solvent was removed in vacuo and the residue purified by flash chromatography (petrol/EtOAc, 9/1) to give the title compound 16 as a colourless oil (7.81 g, 70%). R_{f} 0.5 (petrol/EtOAc, 9/1); ¹H NMR (CDCl₃): δ1.24 (t, J=7, 3H), 1.72-1.80 (m, 2H), 2.36 (s, 6H), 2.70-2.78 (m, 2H), 3.59 (q, J=7, 2H), 3.77 (t, J=5.5, 2H), 3.81 (s, 3H), 4.09 (q, J=5.5, 2H), 6.82 (d, J=8.5, 2H), 6.92 (d, J=8.5, 2H), 7.07 (d, J=8.5, 2H), 7.18 (d, J=8, 4H), 7.38 (d, J=8, 4H), 7.40 (d, J=8.5, 2H); ¹³C NMR (CDCl₃) δ 15.29 (q), 16.57 (t), 21.55 (2xq), 30.39 (t), 55.11 (q), 66.91 (t), 67.59 (t), 69.12 (t), 114.07 (2xd), 114.66 (2xd), 127.96 (s), 128.75 (2xd), 129.13 (4xd), 133.76 (2xs), 134.98 (4xd), 136.27 (2xd), 137.22 (s), 138.70 (2xs), 157.04 (s), 160.37 (s); IR (neat) 3010, 2972, 2925, 1593, 1567, 1510, 1454, 1392, 1281, 1247, 1180, 1090, 1031 cm⁻¹; MS (EI+) m/z 556 (M⁺); HRMS (EI+) calcd. for C₃₃H₃₈Ge⁷⁴O₃ (M⁺) 556.2033, found 556.2042.

### Chloro-{2-[4(2-ethoxy-ethoxy)-phenyl]-ethyl}-di-p-tolyl-germane 17

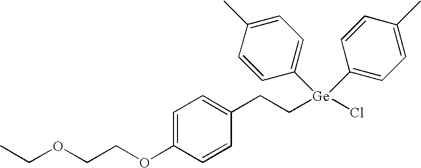 To anisolegermane 16 (100 mg, 0.18 mmol) was added HCl (7.0 ml, 1.0M, 7.0 mmol) in Et₂O and the reaction left to stir for 16 hrs. The solvent was then removed in vacuo to give chlorogermane 17 as a colourless oil (85.3 mg, 98%). ¹H NMR (CDCl₃): δ 1.24 (t, J=7, 3H), 1.851.92 (m, 2H), 2.37 (s, 6H), 2.80-2.87 (m, 2H), 3.60 (q, J=7, 2H), 3.77 (t, J=5, 2H), 4.08 (q, J=5, 2H), 6.81 (d, J=8.5, 2H), 7.07 (d, J=8.5, 2H), 7.23 (d, J=8, 4H), 7.45 (d, J=8, 4H); ¹³C NMR (CDCl₃) δ 15.29 (q), 21.63 (t), 21.59 (2xq), 29.20 (t), 66.90 (t), 67.60 (t), 69.08 (t), 114.74 (2xd), 128.89 (2xd), 129.41 (4xd), 132.32 (2xs), 133.49 (4xd), 135.57 (s), 140.36 (2xs), 157.26 (s); IR (neat) 2973, 2924, 2868, 1610, 1584, 1511, 1453, 1393, 1300, 1247, 1177, 1125, 1090 cm⁻¹; MS (EI+) m/z 483 (M⁺); HRMS (EI+) calcd. for C₂₆H₃₁ClGe⁷⁴O₂ (M⁺) 484.1224, found 484.1207; Anal. calcd. for C₂₆H₃₁ClGe⁷⁴O₂: C 64.58, H 6.46, Cl 7.33, found C 64.12, H 6.56, Cl 7.68.

### tert-Butyl-[5-({2-[4-(2-ethoxy-ethoxy)-phenyl]-ethyl}-di-p-tolyl-germanyl)-4-hexyl-thiophen-2-yl]-dimethyl-silane 18

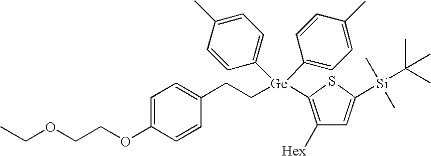 A solution of LDA (4.71 mL, 2.0M, 1.13 mmol) in hexanes/THF/ethylbenzene was added drop-wise to a degassed solution of silylthiophene 10 (1.18 g, 6.28 mmol) in THF (20 mL) at −50° C. This solution was warmed to −40° C., stirred for 40 min at this temperature and recooled to −50° C. It was then transferred by cannula to a degassed solution of chloroditolylgermane 17 (2.69 g, 5.56 mmol) in THF (20 mL) at −50° C. The resulting mixture was stirred for 1 hr at −40° C., warmed to RT and stirred for a further 1 hr. After quenching with sat. NH₄Cl (aq) (50 mL), the mixture was extracted with Et₂O (3×50 mL), the combined organic extracts dried (MgSO₄) and the solvent removed in vacuo. Purification by flash chromatography (petrol/EtOAc, 9/1) gave silylthiopheneditolylgermane 18 as a pale yellow oil (803 mg, 80%). R_{f} 0.3 (9/1, petrol/EtOAc); ¹H NMR (CDCl₃): δ 0.27 (s, 6H), 0.78 (t, J=7.5, 3H), 0.80-1.26 (m, 21H), 1.76-1.84 (m, 2H), 2.35 (s, 6H), 3.36-3.42 (m, 2H), 2.69-2.73 (m, 2H), 3.59 (q, J=7, 2H), 3.76 (t, J=5, 2H), 4.08 (q, J=5, 2H), 6.81 (d, J=8.5, 2H), 7.05 (d, J=8.5, 2H), 7.17 (d, J=8, 4H), 7.18 (s, 1H), 7.39 (d, J=8, 4H); ¹³C NMR (CDCl₃) δ 4.60 (2xq), 14. 22 (q), 15.35 (q), 17.08 (s), 18.42 (t), 21.61 (2xq), 22.70 (t), 26.62 (3xq), 29.42 (t), 30.51 (t), 31.36 (t), 31.72 (t), 31.78 (t), 66.92 (t), 67.63 (t), 69.18 (t), 114.71 (2xd), 128.85 (2xd), 129.16 (4xd), 133.59 (2xs), 134.57 (s), 134.88 (4xd), 137.19 (s), 138.12 (d), 138.82 (2xs), 142.42 (s), 151.65 (s), 157.13 (s); IR (neat) 2955, 2929, 2857, 1610, 1509, 1457, 1391, 1300, 1278, 1250, 1177, 1122, 1087 cm⁻¹; MS (EI+) m/z 730 (M⁺). HRMS (EI+) calcd. for C₄₂H₆₀Ge⁷⁴O₂SSi (M⁺) 730.3295, found 730.3298.

### {2-[4-(2-Ethoxy-ethoxy)-phenyl]-ethyl}-(3-hexyl-thiophen-2-yl)-di-p-tolyl-germane 19

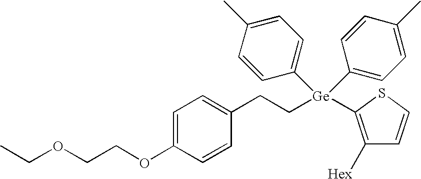 To silyl protected germylthiophene 18 (225 mg, 0.31 mmol) in DMF (3 mL) was added ceasium fluoride (234 mg, 1.54 mmol) and the mixture left to stir for 24 hrs at 110° C. The reaction mixture was partitioned between Et₂O (40 mL) and water (75 ml) and the Et₂O layer extracted with water (3×40 mL). The organic layer was dried (MgSO₄), the solvent removed in vacuo and the residue purified by flash chromatography (petrol/EtOAc, 9/1) to give germylthiophene 19 as a pale yellow oil (182 mg, 95%). R_{f} 0.3 (petro/EtOAc, 9/1); ¹H NMR (CDCl₃): δ 0.81 (t, J=7.5, 3H), 0.83-1.37 (m, 11H), 1.80-1.87 (m, 2H), 2.35 (s, 6H), 2.44 (t, J=8, 3H), 2.74-2.82 (m, 2H), 3.61 (q, J=7, 2H), 3.79 (t, J=5,2H), 4.10 (q, J=5, 2H), 6.84 (d, J=8.5, 2H), 7.09 (d, J=8.5, 2H), 7.12 (d, J=5, 1H), 7.20 (d, J=8, 4H), 7.43 (d, J=8, 4H), 7.54 (d, J=5, 1H); ¹³C NMR (CDCl₃) δ 14. 28 (q), 15.39 (q), 18.41 (t), 21.64 (2xq), 22.73 (t), 29.43 (t), 30.61 (t), 31.59 (t), 31.77 (t), 31.83 (t), 66.95 (t), 67.67 (t), 69.21 (t), 114.77 (2xd), 128.89 (2xd), 129.24 (4xd), 130.09 (d), 130.33 (d), 133.51 (2xs), 134.86 (4d, s), 137.09 (s), 138.97 (2xs), 150.84 (s), 157.20 (s); IR (neat) 2929, 2860, 1610, 1510, 1457, 1392, 1300, 1258, 1245, 1178, 1123, 1087 cm⁻¹; MS (EI+) m/z 616 (M⁺); HRMS (EI+) calcd. for C₃₆H₄₆Ge⁷⁴O₂S (M⁺) 616.2430, found 616.2435.

### {2-[4-(2-Ethoxy-ethoxy)-phenyl]-ethyl}-(3-hexyl-5-iodo-thiophen-2-yl)-di-p-tolyl-germane 20

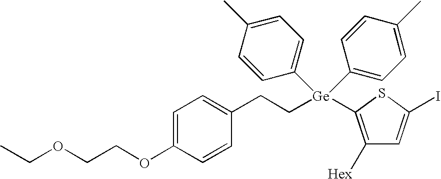 A solution of LDA (0.545 mL, 2.0M, 1.09 mmol) in hexanes/THF/ethylbenzene was added drop-wise to a solution of germylthiophene 19 (224 mg, 0.36 mmol) in THF (3 mL) at −50° C. After stirring for 40 min at −40° C., a solution of degassed 12-diiodoethane (1.56 g, 5.52 mmol) in THF (2 mL) was added by cannula at −50° C. The resulting mixture was stirred in the dark for 1 hr at −40° C., warmed to RT and stirred for a further 1 hr. The reaction mixture was partitioned between sat. Na₂S₂O₃ (aq) (200 mL) and Et₂O (100 ml), extracted with Et₂O (2×100 mL), the organics combined and then dried (MgSO₄). The solvent was removed in vacuo and the residue purification by flash chromatography (petrol/EtOAc, 9/1) to give germylthiopheneiodide 20 as a pale yellow oil (251 mg, 94%). R_{f} 0.5 (petrol/EtOAc, 9/1); ¹H NMR (CDCl₃): δ 0.79 (t, J=7.5, 3H), 0.87-1.30 (m, 11 H), 1.76-1.83 (m, 2H), 2.342.41 (m, 8H), 2.71-2.78 (m, 2H), 3.60 (q, J=7, 2H), 3.78 (t, J=5, 2H), 4.09 (q, J=5, 2H), 6.82 (d, J=8.5, 2H), 7.06 (d, J=8.5, 2H), 7.17 (s, 1H), 7.19 (d, J=8, 4H), 7.38 (d, J=8, 4H); ¹³C NMR (CDCl₃) δ 14. 16 (q), 15.29 (q), 18.15 (t), 21.57 (2xq), 22.58 (t), 29.22 (t), 30.40 (t), 31.31 (t), 31.52 (t), 31.65 (t), 66.89 (t), 67.59 (t), 69.11 (t), 77.71 (s), 114.70 (2xd), 128.75 (2xd), 129.24 (4xd), 132.83 (2xs), 134.66 (4d, s), 136.72 (s), 139.15 (2xs), 139.75 (d), 152.70 (s), 157.13 (s); IR (neat) 2925, 2857, 1610, 1510, 1454, 1393, 1299, 1246, 1178, 1124, 1087 cm⁻¹; MS (ES+) m/z 765 (MNa); HRMS (ES+) calcd. for C₃₆H₄₅Ge⁷⁴¹NaO₂S (MNa) 765.1295, found 765.1266.

### tert-Butyl-[5′-({2-[4-(2-ethoxy-ethoxy)-phenyl]-ethyl}-di-p-tolylgermanyl)4,3′-dihexyl-[2,2′]bithiophen-5-yl]-dimethyl-silane 21

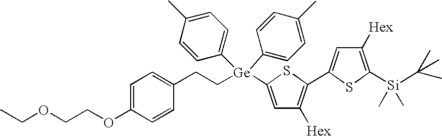 To a degassed solution of silylthiophene pinacolato-boronic ester 11 (256 mg, 1.05 mmol) and germylthiopheneiodide 20 (155 mg, 0.21 mmol) in DMF (1 mL) was added Pd(PPh₃)₄ (23.1 mg, 0.02 mmol) and the resulting mixture stirred at 60° C. for 24 hr. The reaction mixture was partitioned between water (100 mL) and Et₂O (50 ml), extracted with Et₂O (2×50 mL) and the organics combined and dried (MgSO₄). The solvent was removed in vacuo and the residue purification by flash chromatography (petrol/DCM, 2/1) to give silyl protected germyldithiophene 21 as a yellow oil (112 mg, 60 %). R, 0.5 (petrol/DCM, 2/1); ¹H NMR (CDCl₃): δ 0.27 (s, 6H), 0.75-1.36 (m, 34H), 1.76-1.84 (m, 2H), 2.32-2.39 (m, 8H), 2.71-2.80 (m, 4H), 3.59 (q, J=7, 2H), 3.76 (t, J=5, 2H), 4.08 (q, J=5, 2H), 6.82 (d, J=8.5, 2H), 6.99 (s, 1H), 7.07 (d, J=8.5, 2H), 7.11 (s, 1H), 7.18 (d, J=8, 4H), 7.42 (d, J=8, 4H); ¹³C NMR (CDCl₃) δ 4.96 (2xq), 14. 11 (2xq), 15.21 (q), 16.94 (s), 18.23 (t), 21.50 (2xq), 22.56 (t), 22.66 (t), 26.41 (3xq), 29.25 (t), 29.31 (2xt), 30.41 (t), 30.71 (t), 31.33 (t), 31.67 (2xt), 31.78 (t), 66.84 (t), 67.53 (t), 69.06 (t), 114.61 (2xd), 128.42 (d), 128.71 (2xd), 128.97 (s), 129.08 (4xd), 133.26 (2xs), 134.72 (4xd), 135.06 (s), 136.49 (s), 136.99 (s), 138.34 (d), 138.87 (2xs), 140.18 (s), 141.12 (s), 151.03—(s), 156.99 (s); IR (neat) 2924, 2854, 1610, 1509, 1455, 1390, 1246, 1175, 1124, 1086, 1007 cm⁻¹; MS (EI+) m/z 896 (M⁺). HRMS (ES+) calcd. for C₅₂H₇₄Ge⁷⁴NaO₂S₂Si (MNa⁺) 919.4009, found 919.4001.

### EXAMPLE 2

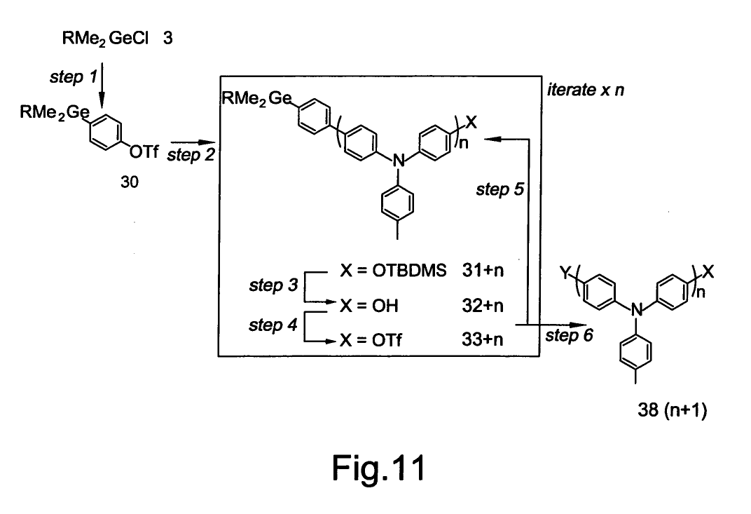

To further exemplify the invention, example 2 relates to a solution phase model of a high purity arylamine oligomer using a germyl linker. Assembly of the oligomer is a stepwise process in which each monomer unit is added sequentially through repetitive transition metal mediated coupling in order to obtain highly pure and well-defined structures. The model reactions for a solid phase synthesis is outlined in FIG. 11 and whose steps may be summarised as
Step 1: attachment and functionalisation of the germyl linker
Step 2: attachment of the first TBDMS protected monomer
Step 3: cleavage of TBDMS protecting group
Step 4: conversion to a triflate coupling precursor
Step 5: cross-coupling of a second monomer
Step 6: removal of the oligomer from the germanium-based linker

Steps 3, 4 and 5 represent the repetitive steps for the oligomer build-up. The role of the TBDMS group is to protect the phenol during the Suzuki-type cross-coupling.

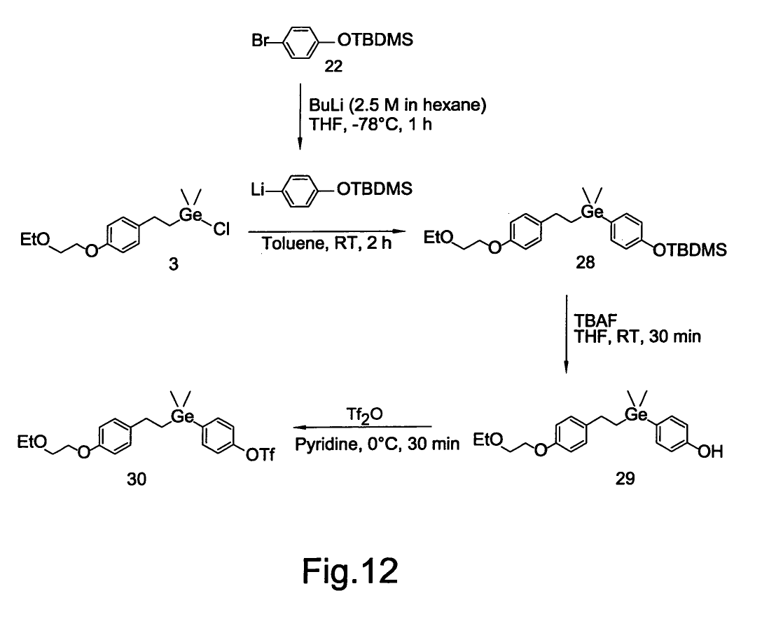

Step 1: (FIG. 12)

Arylgermane 3 was prepared by transmetalation with lithiated (4-bromo-phenoxy)-tert-butyl-dimethyl-silane 22 in 77% yield. TBDMS protecting group in tert-butyl-[4-({2-[4-(2-ethoxy-ethoxy)-phenyl]-ethyl}-dimethyl-germanyl)-phenoxy]-dimethyl-silane 28 was then cleaved using tetrabutylammonium fluoride in THF to give gave germylphenol 29 in 76% yield, with no detectable cleavage of the germyl linker. Conversion of germylphenol 29 into germyltrifluoromethanesulfonate using trifluoromethanesulfonic anhydride in anhydrous pyridine 30 was achieved in 87% yield.

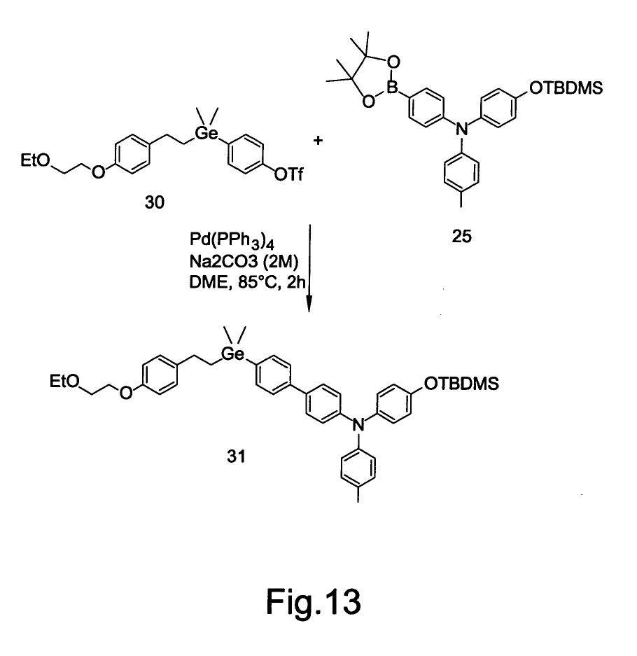

Step 2: (FIG. 13)

The first TBDMS protected amine monomer 34 was attached to germyltrifluoromethanesulfonate 33 was cross-coupled with monomer 34, using a Suzuki-type protocol, with 5% mol Pd(PPh₃)₄ in 1,2-dimethoxyethane at 80° C., to to give germylamine 31 in 84% yield. No detectable cleavage of the germyllinker and of the TBDMS protecting group occurs under these conditions.

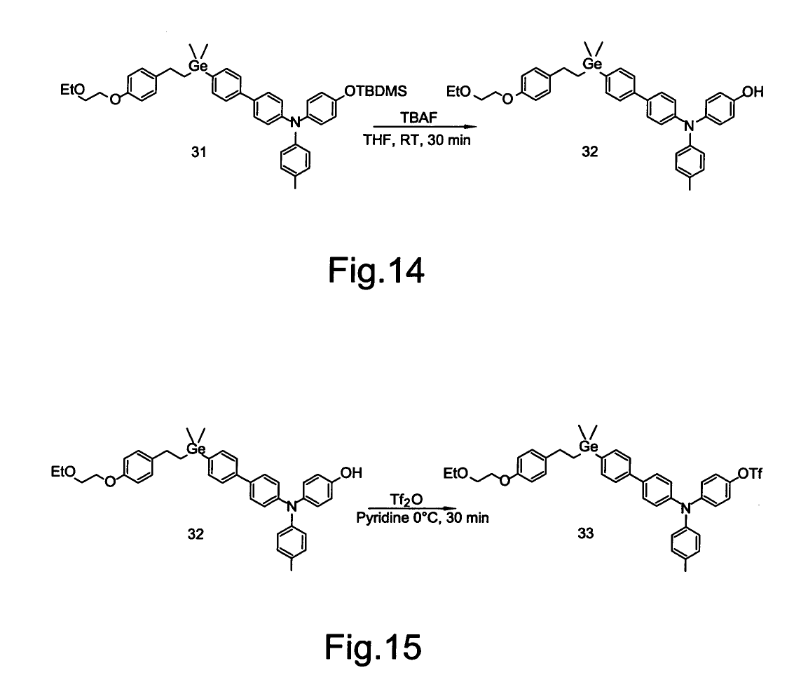

Step 3: (FIG. 14)

Cleavage of the TBDMS protecting group in germylamine 31 was achieved using tetrabutylammonium fluoride in THF and gave germylphenol 32 in 90% yield with no detectable cleavage of the germyl linker.

Step 4: (FIG. 15)

Conversion of the germylphenol 32 into the germyltrifluoromethanesulfonate 33 was achieved using trifluoromethanesulfonic anhydride in anhydrous pyridine. Under these conditions, compound 33 was prepared in 86% yield.

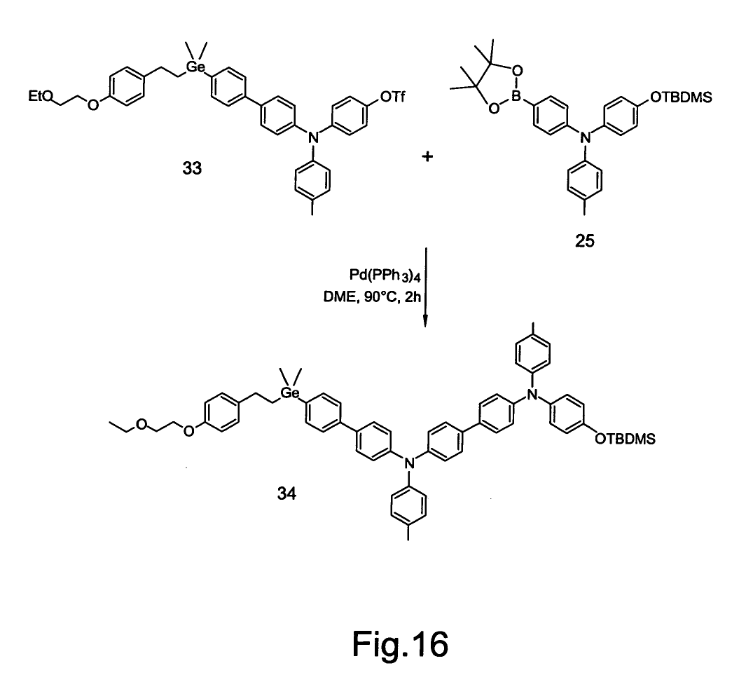

Step 5: (FIG. 16) Germyltrifluoromethanesulfonate 33 was coupled to the amine monomer 25 using 5% mol Pd(PPh₃)₄ in 1,2-dimethoxyethane at 80° C. to give germylamine 34 in 71% yield. No detectable cleavage of the germyl linker occurs under these conditions.

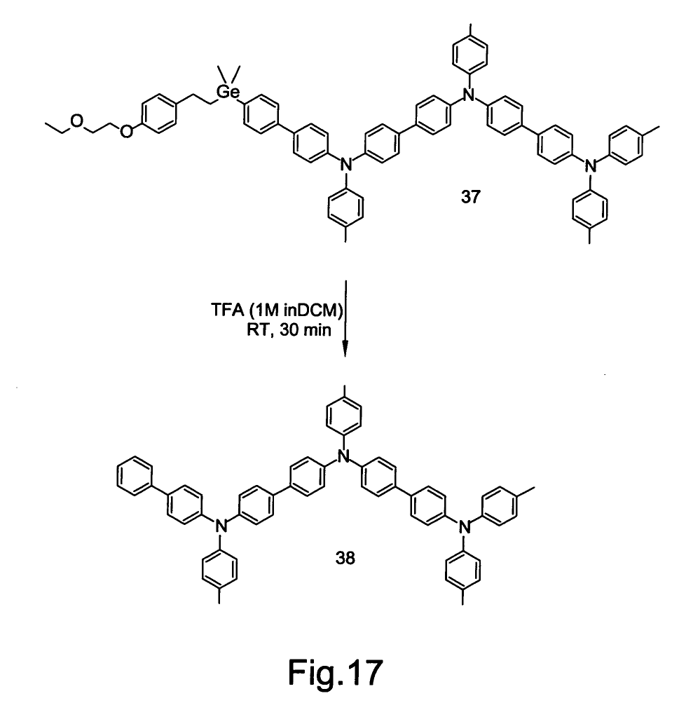

Step 6: (FIG. 17)

This step is carried out as described in step 5 in example 1.

FIG. 11 illustrates the envisaged key steps in the iterative solid phase synthesis of an arylamine.

FIG. 12 illustrates the attachment and the functionnalisation of the germyl linker.

FIG. 13 illustrates linking of a protected arylamine monomer to the germyl linker.

FIG. 14 illustrates a proposed deprotection protocol.

FIG. 15 illustrates a proposed conversion into a trifluoromethanesulfonate protocol.

FIG. 16 illustrates a proposed coupling protocol.

FIG. 17 illustrates a proposed cleavage protocol.

Experimental Procedures

All compounds were characterised by NMR spectroscopy, elemental analysis and/or mass spectrometry and found to be consistent with the expected structures.

### (4-Bromo-phenoxy)-tert-butyl-dimethyl-silane 22

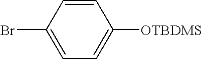 This compound was prepared in a similar way to that described in G. R. Pettit, M. P. Grealish, M. K. Jung, E. Hamel, R. K. Robin, J. -C. Chapuis, J. M. Schmidt, J. Med. Chem, 45, 12, 2002, 2534-2542.
tert-Butyldimethylsilylchloride (18.40 g, 12.2×10⁻² mol) was added slowly to a solution of 4-bromophenol (19.99 g, 11.6×10⁻² mol) and imidazole (16.2 g, 23.8×10⁻² mol) in N,N-dimethylformamide (50 mL) at room temperature. The mixture was stirred at room temperature for 24 h. The mixture was then partitioned between water and hexane. The organic layer was separated off and the aqueous phase was further extracted with hexane. The combined organic fractions were dried over magnesium sulfate, filtered and concentrated in vacuo to give a colourless oil (32.89 g, 11.5×10⁻² mol).

Yield: 99%

### [4-(tert-Butyl-dimethylsilanyloxy)-phenyl]-p-tolyl-amine 23

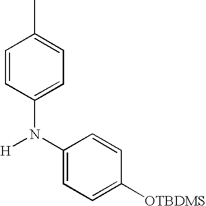

Procedure A

A solution of p-toluidine (6.41 g, 5.98×10⁻² mol), (4-bromo-phenoxy)-tert-butyl-dimethyl-silane 22 (15.64 g, 5.44×10⁻² mol), sodium tert-butoxide (6.73 g, 7.00×10⁻² mol), rac-binap (0.23 g, 0.37×10⁻³ mol), Pd₂(dba)₃, (dba=dibenzylidene acetone), (0.48 g, 0.52×10⁻³ mol) in toluene (200 mL) was stirred vigorously overnight at 100° C. The crude product was a brown oil. Purification by column chromatography (eluent: dichloromethane/hexane 1/3) gave the expected product as a colourless oil (12.6 g, 4.02×10⁻² mol). Yield: 74%.

### (4-Bromo-phenyl)-[4-(tert-butyl-dimethyl-silanyloxy)-phenyl]-p-tolyl-amine 24

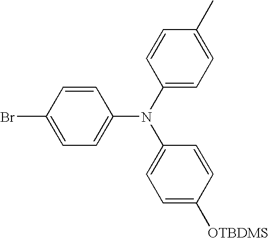 This compound was prepared according to procedure A from [4-(tert-butyl-dimethyl-silanyloxy)phenyl]-p-tolyl-amine 23 (7.00 g, 1.80×10⁻² mol), 4-bromo-iodo-benzene (5.53 g, 1.95×10⁻³ mol), sodium tert-butoxide (3.71 g, 3.86×10⁻² mmol), rac-binap (0.11 g, 0.17×10⁻³ mol) and Pd₂(dba)₃ (0.05 g, 0.06×10⁻³ mol) in toluene (150 mL). The reaction mixture was then cooled to room temperature and filtered. The filtrate was taken up in diethylether, washed with water, dried over magnesium sulfate, filtered and concentrated in vacuo to give a brown oil. Purification by column chromatography (eluent: dichloromethane/hexane 1/5) gave the expected product as a colourless solid (5.4 g, 1.15×10⁻² mol). Yield: 52%.

### [4-(tert-Butyl-dimethyl-silanyloxy)-phenyl]-[4-(4,4,5,5-tetramethyl-[1,3,2]dioxaborolan-2-yl)-phenyl]-p-tolyl-amine 25

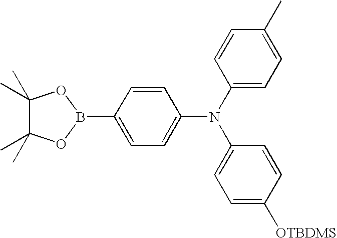

Procedure B

A solution of n-butyllithium (2.5M in hexane) (2.61 mL, 6.53×10⁻³ mol) was added drop-wise to a solution of (4-bromo-phenyl)-[4-(tert-butyl-dimethyl-silanyloxy)-phenyl]-p-tolyl-amine 24 (2.04 g, 4.35×10⁻³ mol) in tetrahydrofuran cooled at −78° C. The resulting mixture was stirred at −78° C. for 1 h. 2-Isopropoxy-4,4,5,5-tetramethyl-[1,3,2]-dioxaborolane (1.21 g, 6.50×10⁻³ mol) was added to the resulting solution and after 15 minutes, the reaction mixture was allowed to warm up to room temperature and stirred overnight. The mixture was then partitioned between water and dichloromethane. The organic layer was separated off and the aqueous phase was extracted with dichloromethane. The combined organic fractions were dried over magnesium sulfate, filtered and concentrated in vacuo to give a yellow solid. Recrystallisation from MeOH afforded the expected product as white needles (1.58 g, 3.06×10⁻³ mol). Yield: 70%.

### (4-Bromo-phenyl)-di-p-tolyl-amine 26

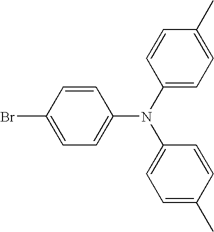 Di-p-tolyl-amine (25.00 g, 12.7×10⁻² mol), 4-bromo-iodobenzene (43 g, 15.2×10⁻² mol), potassium hydroxyde (79.6 g, 141.9×10² mol) were suspended in o-xylene (100 mL) and the mixture was then heated to 100° C. To this suspension were added copper chloride (2.51 g, 2.5×10⁻² mol) and 1,10-phenanthroline (4.57 g, 2.5×10⁻² mol) and the mixture was stirred vigorously 1 h at 145° C. Toluene was then added and the reaction mixture was filtered. The filtrate was concentrated in vacuo to give a brown oil. Purification by column chromatography (eluent: hexane) and recrystallisation from methanol gave the expected product as a white solid (24.4 g, 6.92×10⁻² mol). Yield: 55%.

### [4-(4,4,5,5-Tetramethyl-[1,3,2]dioxaborolan-2-yl)-phenyl]-di-p-tolyl-amine 27

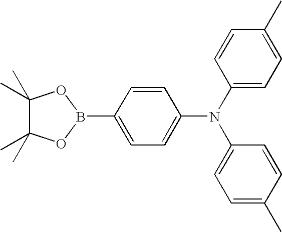 This compound was prepared according to procedure B from (4-bromo-phenyl)-di-p-tolyl-amine 26 (2.00 g, 5.68×10⁻³ mol), n-butyllithium (2.5M in hexane) (3.4 mL, 8.50×10⁻³ mol) and 2-isopropoxy-4,4,5,5-tetramethyl-[1,3,2]-dioxaborolane (1.58 g, 8.50×10⁻³ mol). The combined organic fractions were dried over magnesium sulfate, filtered and concentrated in vacuo to give a light yellow solid. Recrystallisation from MeOH afforded the expected product as white needles (1.60 g, 4.00×10⁻³ mol). Yield: 71%.

### tert-Butyl-[4-({2-[4-2-ethoxy-ethoxy)-phenyl]-ethyl}-dimethyl-germanyl)-phenoxy]-dimethyl-silane 28

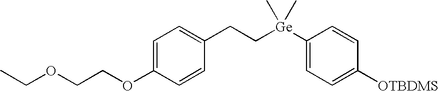 A solution of n-butyllithium (2.5 M in hexane) (5.8 mL, 1.45×10⁻² mol) was added drop-wise to a solution of (4-bromo-phenoxy)-tert-butyl-dimethyl-silane 22 (4.16 g, 1.45×10⁻² mol) in tetrahydrofuran (40 mL) at −78° C. After being stirred for 45 min, the mixture was transferred by cannula to a solution of (2-[4-(2-ethoxy-ethoxy)phenyl]-ethyl)-dimethyl-germyl-chloride (2.25 g, 6.79×10⁻³ mol) in toluene (50 mL) at −78° C. The mixture was stirred for 3 h at room temperature. The reaction was then quenched with an aqueous solution of HCl (1 M) and extracted with diethylether. The organic fractions were collected, dried over magnesium sulfate, filtered and concentrated in vacuo to give a yellow oil. Purification by column chromatography (eluent:hexane/ethyl acetate 10/1) gave the expected product as a colourless liquid (2.63 g, 5.23×10⁻³ mol).

Yield: 77%

### 4-({2-[4-(2-Ethoxy-ethoxy)-phenyl]-ethyl}dimethyl-germanyl)-phenol 29

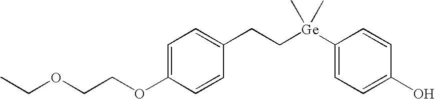

Procedure C

A solution of tetrabutylammonium fluoride (1.54 g, 4.88×10⁻³ mol) in tetrahydrofuran (50 mL) was added drop-wise to a solution of tert-butyl-[4({2-[4-(2-ethoxy-ethoxy)phenyl]-ethyl}-dimethyl-germanyl)-phenoxy]-dimethyl-silane 28 (2.45 g, 4.88×10⁻³ mol) in tetrahydrofuran (100 mL) at room temperature. The resulting mixture was stirred at room temperature for 30 min. The solvent was removed under reduced pressure and the residue was dissolved in dichloromethane and washed with water. The organic layer was then dried over magnesium sulfate, filtered and concentrated in vacuo to give a yellow oil. Purification by column chromatography (eluent:hexane/ethyl acetate 4/1) gave the expected product as a colourless liquid (1.42 g, 3.70×10⁻³ mol). Yield: 76%.

### 4-({2-[4-(2-Ethoxy-ethoxy)-phenyl]-ethyl}-dimethyl-germanyl)phenyl-trifluoromethanesulfonate 30

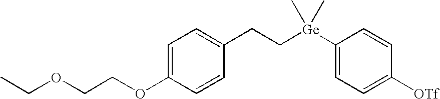

Procedure D

Trifluoromethanesulfonic anhydride (0.88 g, 3.12×10⁻³ mol) was added slowly to a solution of 4-({2-[4-(2-ethoxy-ethoxy)phenyl]-ethyl}dimethyl-germanyl)-phenol 29 (1.22 g, 3.14×10⁻³ mol) in pyridine (6 mL) at 0° C. The resulting mixture was stirred at 0° C. for 5 min, then allowed to warm to room temperature and stirred at this temperature for a further 16 h. The reaction mixture was then poured into water and extracted with diethylether. The organic fractions were collected, washed sequentially with water, 10% aqueous HCl solution, water and brine, dried over magnesium sulfate, filtered and concentrated in vacuo to give a yellow oil. Purification by column chromatography (eluent: hexane/ethyl acetate 5/1) gave the expected product as a colourless liquid (1.42 g, 2.72×10⁻³ mol). Yield: 87%.

### [4-(tert-Butyl-dimethyl-silanyloxy)-phenyl]-[4′-({2-[4-(2-ethoxy-ethoxy)phenyl]-ethyl}-dimethyl-germanyl)-biphenyl-4-yl]-p-tolyl-amine 31

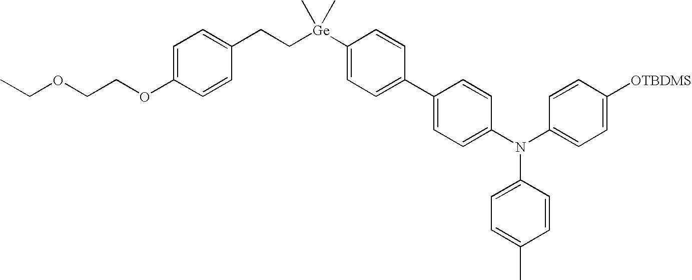

Procedure E

A mixture of 4-({2-[4(2-ethoxy-ethoxy)phenyl]-ethyl}dimethyl-germanyl)-phenyl-trifluoromethanesulfonate 30 (0.40 g, 0.77×10⁻³ mol), [4-(tert-butyl-dimethyl-silanyloxy)-phenyl]-[4-(4,4,5,5-tetramethyl-[1,3,2]dioxaborolan-2-yl)-phenyl]-p-tolyl-amine 25 (0.40 g, 0.77×10⁻³ mol), Pd(PPh₃)₄ (44 mg, 3.8×10⁵ mol), aqueous Na₂CO₃ (2M) (8 mL) in 1,2-dimethoxyethane (8 mL) was heated at 80° C. with vigorous stirring. After 2 h, the reaction was cooled to room temperature and the solvent was removed under reduced pressure. The residue was then partitioned between dichloromethane and 2M Na₂CO₃ aqueous solution. The organic phase was separated and the aqueous phase was extracted further with dichloromethane. The dichloromethane fractions were combined and dried over magnesium sulfate, filtered and concentrated in vacuo to give a brown oil. Purification by column chromatography (eluent:hexane/ethyl acetate 19/1) gave the expected product as a colourless oil (0.49 g, 0.64×10⁻³ mol). Yield: 84%.

### 4-{[4′-({2-[4-2-Ethoxy-ethoxy-phenyl]-ethyl}-dimethyl-germanyl)-biphenyl-4-yl]-p-tolyl-amino}-phenol 32

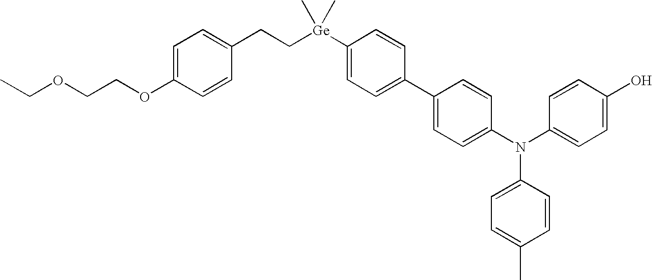 This compound was prepared according to procedure C from (4(tert-butyl-dimethyl-silanyloxy)-phenyl-[4′({2-[4-(2-ethoxy-ethoxy)phenyl]-ethyl}-dimethyl-germanyl)-biphenyl-4-yl]-p-tolyl-amine 31 (0.46 g, 0.60×10⁻³ mol) and tetrabutylammonium fluoride (0.20 g, 0.63×10⁻³ mol) in tetrahydrofuran (23 mL) After removal of the solvent under reduced pressure, the residue was dissolved in dichloromethane and the organic solution was washed with water. The organic phase was then separated, dried over magnesium sulfate, filtered and concentrated in vacuo to give a yellow oil. Purification by column chromatography (eluent:hexane/ethyl acetate 7/3) gave the expected product as a colourless oil (0.35 g, 0.54×10⁻³ mol). Yield: 90%.

### 4-{[4′-({2-[4-2-Ethoxy-ethoxy)-phenyl]-ethyl}-dimethyl-germanyl)-biphenyl-4-yl]-p-tolyl-amino}-phenyl-trifluoromethanesulfonate 33

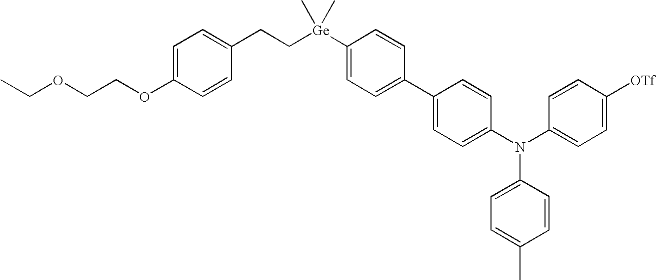 This compound was prepared according to procedure D from 4{[4′-({2-[4(2-ethoxy-ethoxy)phenyl]-ethyl}dimethyl-germanyl)biphenyl-4-yl]-tolyl-amino}-phenol 32 (0.33 g, 0.50×10⁻³ mol) and trifluoromethanesulfonic anhydride (0.14 g, 0.50×10⁻³ mol) in pyridine (5 mL). The reaction mixture was poured into water and extracted with Et₂O. The organic fractions were collected, washed sequentially with water, 10% aqueous HCl solution, water and brine. The organic solution was dried over magnesium sulfate, filtered and concentrated in vacuo to give a yellow oil. Purification by column chromatography (eluent: hexane/ethyl acetate 10/1) gave the expected product as a colourless glassy solid (0.34 g, 0.44×10⁻³ mol). Yield: 86%.

### N^{-4′}-[4-(tert-Butyl-dimethyl-silanyloxy)-phenyl]-N⁴-[4′-({2-[4-(2-ethoxy-ethoxy)-phenyl]-ethyl}-dimethyl-germanyl)-biphenyl-4-yl]-N⁴,N^{4′}-di-p-tolyl-biphenyl-4,4′-diamine 34

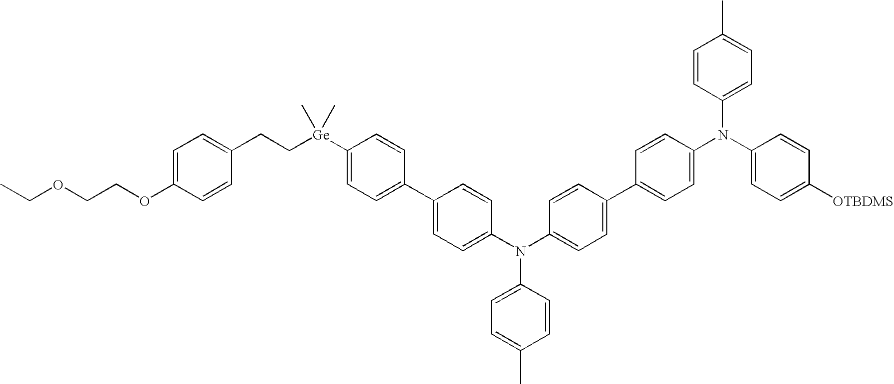 This compound was prepared according to procedure E from 4{[4′-({2-[4(2-ethoxy-ethoxy)phenyl]-ethyl}dimethyl-germanyl)-biphenyl-4-yl]-p-tolyl-amino}phenyl-trifluoromethanesulfonate 33 (0.30 g, 0.39×10⁻³ mol), [4-(tert-butyl-dimethyl-silanyloxy)-phenyl]-[4-(4,4,5,5-tetramethyl-[1,3,2]dioxaborolan-2-yl)-phenyl]-p-tolyl-amine 25 (0.20 g, 0.39×10⁻³ mol), Pd(PPh₃)₄ (22 mg, 1.90×10⁻⁵ mol) and aqueous Na₂CO₃ (2M) (4 mL) in 1,2-dimethoxyethane (8 mL). After removal of the solvent under reduced pressure, the residue was partitioned between dichloromethane and 2 M Na₂CO₃ aqueous solution. The organic phase was separated and the aqueous phase was extracted with further portions of dichloromethane. The combined organic fractions were dried over magnesium sulfate, filtered and concentrated in vacuo to give a brown oil. Purification by column chromatography (eluent:hexane/ethyl acetate 20/1) gave the expected product as a colourless oil (0.28 g, 0.28×10⁻³ mol). Yield: 71%.

### 4-[(4′-{[4′-({2-[4-2-Ethoxy-ethoxy)-phenyl]-ethyl}-dimethyl-germanyl)biphenyl-4-yl]-p-tolyl-amino}-biphenyl-4-yl)-p-tolyl-amino]-phenol 35

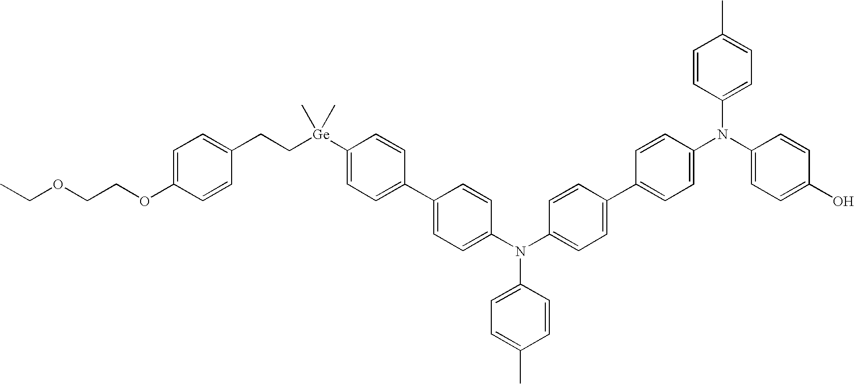 This compound was prepared according to procedure C from the V-[4-(tert-butyl-dimethyl-silanyloxy)phenyl]-N⁴-[4′-({2-[4-(2-ethoxy-ethoxy)-phenyl]-ethyl}-dimethyl-germanyl)-biphenyl-4-yl]-N⁴-N^{4′}-di-p-tolyl-biphenyl-4,4′-diamine 34 (0.27 g, 0.26×10⁻³ mol) and tetrabutylammonium fluoride (0.09 g, 0.28×10⁻³ mol) in tetrahydrofuran (7 mL). After removal of the solvent under reduced pressure, the residue was dissolved in dichloromethane and washed with water. The organic phase was then dried over magnesium sulfate, filtered and concentrated in vacuo to give a yellow oil. Purification by column chromatography (eluent: hexane/ethyl acetate 3/1) gave the expected product as a colourless glassy solid (0.18 g, 0.20×10⁻³ mol). Yield: 75%.

### 4-[(4′-{[4′-({2-[4-(2-Ethoxy-ethoxy)-phenyl]-ethyl}-dimethyl-germanyl)-biphenyl-4-yl]-p-tolyl-amino}-biphenyl-4-yl)-p-tolyl-amino]-phenyl-trifluoromethanesulfonate 36

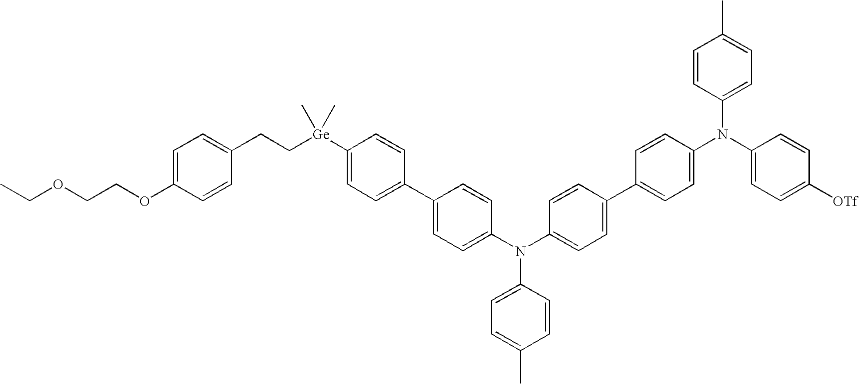 This compound was prepared according to procedure D from 4[(4′-{[4′-({2-[4-(2-ethoxy-ethoxy)-phenyl]-ethyl}-dimethyl-germanyl)-biphenyl-4-yl]-p-tolyl-amino}-biphenyl-4-yl)-p tolyl-amino]-phenol 35 (0.18 g, 0.20×10⁻³ mol) and trifluoromethanesulfonic anhydride (0.06 g, 0.20×10⁻³ mol) in pyridine (5 mL). The reaction mixture was poured into water and extracted with diethylether. The organic fractions were collected, washed sequentially with water, 10% aqueous HCl solution, water and brine. The organic solution was dried over magnesium sulfate, filtered and concentrated in vacuo to give a yellow oil. Purification by column chromatography (eluent:hexane/ethyl acetate 10/1) gave the expected product as a colourless glassy solid (0.19 g, 0.18×10⁻³ mol). Yield: 92%.

### N^{4′}-[4′-(Di-p-tolylamino-biphenyl-4-yl]-N⁴-[4′-({2-[4-(2-ethoxy-ethoxy)-phenyl]-ethyl}-dimethyl-germanyl)-biphenyl-4-yl]-N⁴,N^{4′}-di-p-tolyl-biphenyl-4,4′-diamine 37

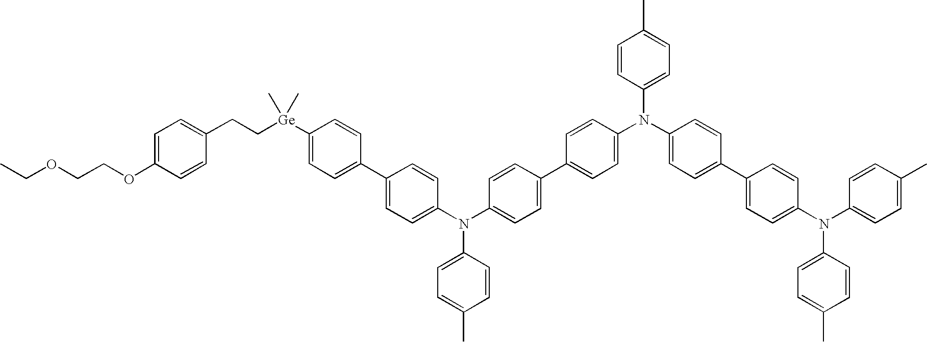 This compound was prepared according to procedure E from 4-[(4′-{[4′-({2-[4(2-ethoxy-ethoxy)-phenyl]-ethyl}-dimethyl-germanyl)-biphenyl-4-yl]-p-tolyl-amino}-biphenyl-4-yl)-p-tolyl-amino]-phenyl-trifluoromethanesulfonate 36 (0.16 g, 0.15×10⁻³ mol), [4-(4,4,5,5-tetramethyl-[1,3,2]dioxaborolan-2-yl)phenyl]-di-p-tolyl-amine 27 (0.06 g, 0.15×10⁻³ mol), Pd(PPh₃)₄ (9 mg, 0.78×10⁻⁵ mol) and aqueous Na₂CO₃ (2M) (2 mL) in 1,2-dimethoxyethane (5 mL). After removal of the solvent under reduced pressure, the residue was partitioned between dichloromethane and 2 M Na₂CO₃ aqueous solution. The organic phase was separated and the aqueous phase was extracted with further portions of dichloromethane. The combined organic fractions were dried over magnesium sulfate, filtered and concentrated in vacuo to give a brown oil. Purification by column chromatography (eluent:hexane/ethyl acetate 17/1) gave the expected product as a white solid (0.13 g, 0.11×10⁻³ mol). Yield: 75%.

### N^{4′}-[4′-(Di-p-tolylamino-biphenyl-4-yl]-N⁴-(4′-biphenyl)-N⁴,N^{4′}-di-p-tolyl-biphenyl-4,4′-diamine 38

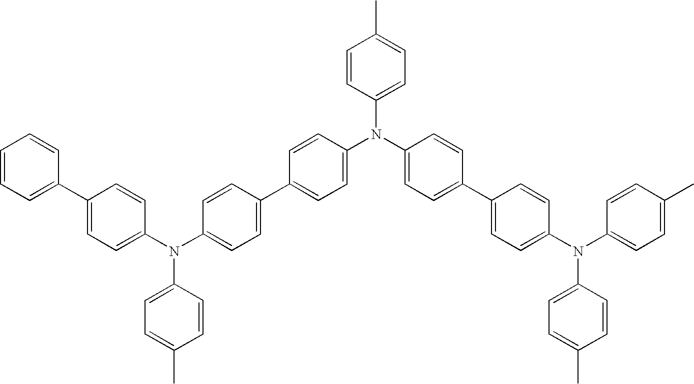 A solution of N⁴-[4′-(Di-p tolylamino-biphenyl-4-yl]-N⁴-[4′-({2-[4-(2-ethoxy-ethoxy)-phenyl]-ethyl}-dimethyl-germanyl)-biphenyl-4-yl]-N⁴,N^{4′}-di-p-tolyl-biphenyl-4,4′-diamine 37 (0.13 g, 0.11×10⁻³ mol) in trifluoroacetic acid (1% in dichloromethane) (5 mL) was stirred at room temperature for 16 h. The solvent was then removed in vacuo, and the crude material was purified by column chromatography (eluent:hexane/ethyl acetate 10/1) to give the expected product as a white solid (0.08 g, 0.07×10⁻³ mol). Yield: 72%.

### EXAMPLE 3

To further exemplify the invention, example 3 relates to assembly of a bithiophene unit in a stepwise process in which each monomer unit is added sequentially to the solid support.

Experimental

All compounds were characterised by gel phase NMR spectroscopy and by elemental analysis and were found to be consistent with the expected structures. Hypogel 200-OH is a low Mw cross-linked polystyrene resin and was purchased from Fluka chemicals.

Bromination of “Hypogel 200-OH” 39 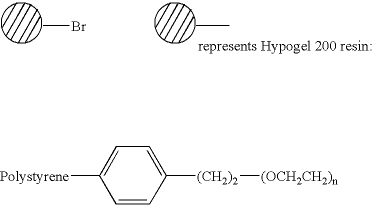
in this and all subsequent structures.
Carbon tetrabromide (26 g, 78.4 mmol) was added to a suspension of Hypogel 200-OH (24.55 g, 19.6 mmol) in/dichloromethane (250 ml). This mixture was cooled/to 0° C., and triphenylphosphine (10.30 g, 39.3 mmol) was added. The mixture was stirred at room temperature under nitrogen for 24 h. After removal of the solvent by filtration, the resin was washed extensively with N₃N-dimethylformamide (1×300 mL), tetrahydrofuran/water (1:1) (2×300 mL), tetrahydrofuran (2×300 ml), methanol (2×300 mL) and was dried for 16 h at 50° C. under vacuo to give 39 as pale yellow granules (25 g). Loading level: 0.8 mmol.g⁻¹ (estimated from Br analysis). Elemental analysis: C, 76.1; H, 7.9; Br 6.5%).
Immobilisation of Linker 40 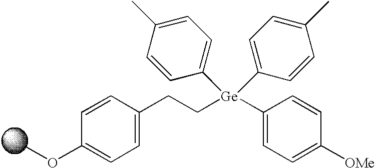
4-{2-[(4-Methoxy-phenyl)-di-p-tolyl-germanyl]-ethyl}-phenol (4.12 g, 8.51 mmol), tetra-n-butylammonium iodide (0.485 g, 1.31 mmol) and cesium carbonate (4.28 g, 13.1 mmol) was added to a suspension of resin 39 (5.45 g, 4.38 mmol) in acetonitrile (30 ml). This mixture was stirred at 85° C. for 22 h. After removal of the solvent by filtration, the resin was washed extensively with acetonitrile (3×100 mL), N,N-dimethylformamide (2×100 mL), tetrahydrofuran/water (1:1) (3×100 mL), tetrahydrofuran (2×100 mL), methanol (2×100 mL) and was dried for 16 h at 50° C. under vacuo to give 40 as pale yellow granules (7.71 g). Loading level: 0.5 mmol.g⁻¹ (estimated from Ge). Elemental analysis: C, 78.0; H, 7.7; Ge,3.5; Br, <1.5%).
Electrophilic Ipso-Cleavage Arylgermane 41 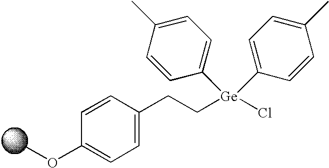
A solution of 1.0M HCl in diethylether (35 mL, 35 mmol) was added to resin 40 (7.30 g, 6.3 mmol). This mixture was stirred at room temperature under nitrogen for 20 h. After removal of the solvent by filtration, the resin was washed with anhydrous diethylether (2×50 mL) and dried at 50° C. under vacuo for 16 h to give resin 41 as pale yellow granules (6.4 g). Loading level: 0.5 mmol.g⁻¹ (estimated from Ge and Cl loadings. Elemental analysis: C, 76.7; H, 7.9; Ge, 3.6; Cl 2.2%.
Immobilization of Thiophene Monomer 10 to Give Resin 42 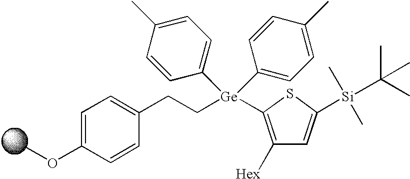
A solution of LDA (3.26 mL, 2.0M, 6.5 mmol) in hexanes/THF/ethylbenzene was added drop-wise to a degassed solution of silylthiophene 10 (1.80 g, 6.4 mmol) in THF (10 mL) at −50° C. This solution was warmed to 40° C., stirred for 40 min at this temperature and recooled to −50° C. It was then transferred by cannula to a degassed suspension of germylchloride resin 41 (3.35 g, LL=0.6 mmolg⁻¹, 2.1 mmol) in THF (10 mL) at −50° C. The resulting mixture was stirred for 1 hr at 40° C., warmed to RT and stirred for a further 16 hr. After quenching with sat. NH₄Cl (aq) (100 mL), the solvent was removed by filtration and the resin washed with DMF (100 mL×3), THF:H₂O 1:1 (100 mL×3), THF (100 mL×3) and MeOH (100 mL×3). The resin was then dried in vacuo at 60° C. to give the required resin 42 as yellow grains (2.679). Elemental analysis: C, 83.3; H, 7.7; N, 0.2; S, 0.4; Ge, 1.9%.
Deprotection of Silyl Protected Thiophene to Give Resin 43 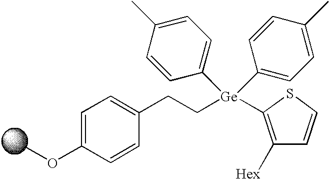
To silyl protected germylthiophene resin 42 (2.00 g, LL=0.6 mmolg⁻¹, 1.24 mmol) in DMF (5 mL) was added ceasium fluoride (1.32 g, 8.68 mmol) and the mixture left to stir for 72 hrs at 110° C. The solvent was then removed by filtration and the resin washed with DMF (75 mL×2), THF:H₂O 1:1 (75 mL×3), THF (75 mL×3) and MeOH (75 mL×3). The resin was then dried in vacuo at 60° C. to give the required resin 43 as beige grains (1.58 g). Elemental analysis: C, 84.0; H, 7.9; N, 0.2; S, 0.5; Ge, 1.8%.
Iodination of Resin Bound Thiophene to Give Resin 44 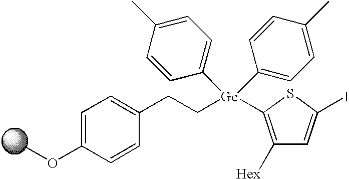
A solution of LDA (1.10 mL, 2.0M, 2.19 mmol) in hexanes/THF/ethylbenzene was added drop-wise to a suspension of germylthiophenes resin 43 (1.18 g, LL=0.6 mmolg⁻¹, 0.73 mmol) in THF (10 mL) at −50° C. After stirring for 40 min at −40° C., a solution of degassed 1,2-diiodoethane (1.03 g, 3.65 mmol) in THF (10 mL) was added by cannula at −50° C. The resulting mixture was stirred in the dark for 1 hr at −40° C., warmed to RT and stirred for a further 1 hr. The solvent was then removed by filtration and the resin washed with Na₂S₂O₃ (aq) (75 mL×3), THF:H₂O 1:1 (75 mL×3), THF (75 mL×3) and MeOH (75 mL×3). The resin was then dried in vacuo at 60° C. to give the required resin 44 as beige grains (0.98 g). IR (neat) 3024, 2919, 1600, 1509, 1492, 1451, 1244, 1106, 1028 cm⁻¹. Elemental analysis: C, 83.0; H, 7.7; N, 0.3; S, 0.4; Ge, 1.7%.
Suzuki Cross-Coupling on Resin 44 to Give Resin 45 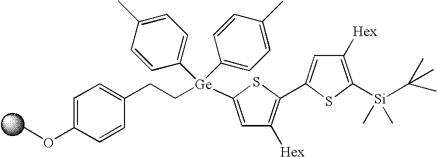
To a degassed solution of silylthiophene pinacolato-boronic ester 11 (502 mg, 1.23 mmol) and germylthiopheneiodide resin 44 (655 mg, LL=0.6, 0.41 mmol) in DMF (5 mL) was added Pd(PPh₃)₄ (23.1 mg, 0.02 mmol) and the resulting mixture stirred at 60° C. for 24 hr. The solvent was then removed by filtration and the resin washed with DMF (50 mL×2), THF:H₂O 1:1 (50 mL×3), THF (50 mL×3) and MeOH (50 mL×3). The resin was then dried in vacuo at 60° C. to give the required resin 45 as beige grains (595 mg). IR (neat) 3024, 2919, 1600, 1509, 1492, 1451, 1244, 1104, 1028 cm⁻¹. Elemental analysis: C, 82.6; H, 7.4; N, 0.2; S, 0.8%.
The following steps were carried out to demonstrate the “double coupling” on the resin
Iodination of Resin Bound Thiophene 46 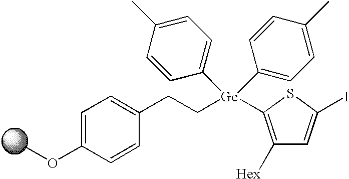
A solution of LDA (1.10 mL, 2.0M, 2.19 mmol) in hexanes/THF/ethylbenzene was added drop-wise to a suspension of germylthiophene resin 45 (314 mg, LL=0.6 mmolg⁻¹, 0.19 mmol) in THF (2 mL) at −50° C. After stirring for 40 min at 40° C., a solution of degassed 1,2-diiodoethane (267 mg, 0.95 mmol) in THF (1 mL) was added by cannula at −50° C. The resulting mixture was stirred in the dark for 1 hr at −40 C., warmed to RT and stirred for a further 1 hr. The solvent was then removed by filtration and the resin washed with Na₂S₂O₃ (aq) (50 mL×3), THF:H₂O 1:1 (50 mL×3), THF (50 mL×3) and MeOH (50 mL×3). The resin was then dried in vacuo at 60° C. to give the required resin 46 as beige grains (272 mg).
Suzuki Cross-Coupling on Resin Bound Thiophene 47

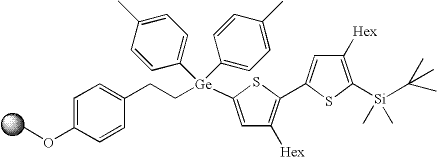

To a degassed solution of silylthiophene pinacolato-boronic ester 11 (208 mg, 0.51 mmol) and germylthiopheneiodide resin 46 (272 mg, LL=0.6, 0.17 mmol) in DMF (2 mL) was added Pd(PPh₃)₄ (9.8 mg, 0.008 mmol) and the resulting mixture stirred at 60° C. for 24 hr. The solvent was then removed by filtration and the resin washed with DMF (50 mL×2), THF:H₂O 1:1 (50 mL×3), THF (50 mL×3) and MeOH (50 mL×3). The resin was then dried in vacuo at 60° C. to give the required resin 47 as beige grains (262 mg). Elemental analysis: C, 81.8; H, 7.0; N, 0.2; S, 0.8%.

### EXAMPLE 4

To further exemplify the invention, example 4 relates to assembly of a triarylamine trimer unit in a stepwise process in which each monomer unit is added sequentially to the solid support.

Experimental

All compounds were characterised by gel phase NMR spectroscopy and by elemental analysis and were found to be consistent with the expected structures.

Attachment of Arylamine Monomer 24 to Give Resin 48

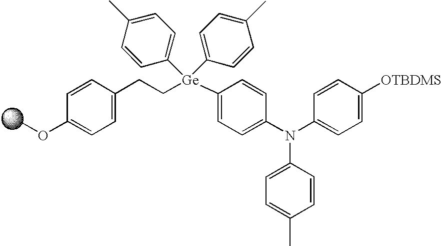

A solution of n-butyllithium (2.5 M in hexane) (3.4 mL, 5.4×10⁻³ mol) was added dropwise to a solution of (4-Bromo-phenyl)-[4-(tert-butyl-dimethyl-silanyloxy)-phenyl]-p-tolyl-amine 24 (2.53 g, 5.4×10⁻³ mol) in tetrahydrofuran (20 mL) at −78° C. After being stirred for 45 min, the mixture was transferred by cannula to a suspension of resin C (3.00 g, 1.5×10³ mol) in toluene (30 mL) at −78° C. The resulting mixture was stirred for 18 h at room temperature. An aqueous solution of HCl (1 M) was then added and the mixture stirred another 30 min. After removal of the solvent by filtration, the resin was washed extensively with N,N-dimethylformamide (1×75 mL), tetrahydrofuran/water (1:1) (2×75 mL), tetrahydrofuran (2×75 mL), methanol (2×75 mL) and was dried for 18 h at 50° C. under vacuo to give resin 48 as pale yellow granules (3.23 g).

Elemental analysis: C, 80.2%; H, 8.0%; N, 0.5%; Ge, 2.7%; Cl, <0.5%
Deprotection of Silyl Protected Resin 48 to Give Resin 49 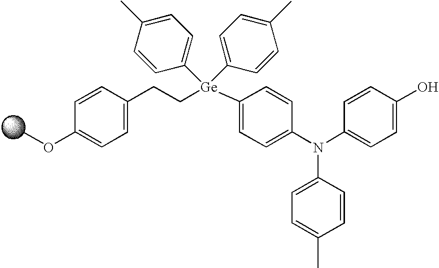
Procedure F
Tetrabutylammonium fluoride (1.34 g, 4.25×10⁻³ mol) was added to a suspension of resin 48 (2.43 g, 1.22×10⁻³ mol) in tetrahydrofuran (20 ml). This mixture was stirred under nitrogen at room temperature for 20 h. After removal of the solvent by filtration, the resin was washed extensively with N,N-dimethylformamide (1×75 mL), tetrahydrofuran/water (1:1) (2×75 mL), tetrahydrofuran (2×75 ml), methanol (2×75 mL) and was dried for 16 h at 50° C. under vacuo to give resin 49 as pale yellow granules (2.33 g).

Elemental analysis: C, 80.8%; H, 7.7%; N, 0.7%; Ge, 2.8%
Triflation of Resin Bound Arylamine 49 to Give Resin 50 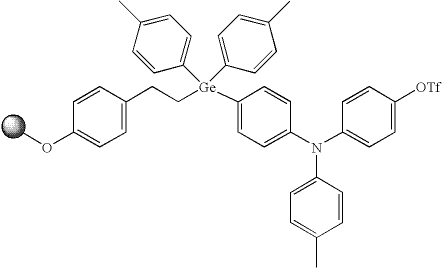
Procedure G
Trifluoromethanesulfonic anhydride (0.50 mL, 2.97×10⁻³ mol) was added slowly to a suspension of resin 49 (1.61 g, 0.81×10⁻³ mol) swollen in pyridine (10 mL) at 0° C. The resulting mixture was stirred at 0° C. for 5 min, then allowed to warm to room temperature and stirred at this temperature for a further 16 h. After removal of the solvent by filtration, the resin was washed extensively with N,N-dimethylformamide (1×75 mL), tetrahydrofuran/water (1:1) (2×75 mL), tetrahydrofuran (2×75 ml), methanol (2×75 mL) and was dried for 16 h at 50° C. under vacuo to give resin 50 as pale yellow granules (1.73 g).

Elemental analysis: C, 76.3%; H, 6.7%; N, 0.7%; S, 1.3%; F, 2.2%; Ge, 2.7%; N, 0.7%;
Suzuki Cross-Coupling on Resin 50 to Give Resin 51

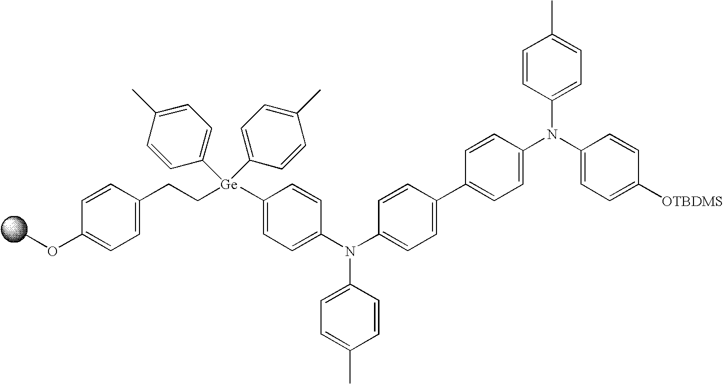

Procedure H

Resin 50 (1.34 g, 0.67×10⁻³ mol), [4(tert-butyl-dimethyl-silanyloxy)-phenyl]-[4-(4,4,5,5-tetramethyl-[1,3,2]dioxaborolan-2-yl)-phenyl]-p-tolyl-amine 25 (1.73 g, 3.35×10⁻³ mol), Pd(PPh₃)₄ (0.15 g, 0.13×10⁻³ mol), aqueous Na₂CO₃ (2M) (10 mL) in 1,2-dimethoxyethane (10 mL) were stirred at 80° C. for 18 h. After removal of the solvent by filtration, the resin was washed extensively with N,N-dimethylformamide (1×50 mL), tetrahydrofuran/water (1:1) (2×50 mL), tetrahydrofuran (2×50 ml), methanol (2×50 mL) and was dried for 16 h at 50° C. under vacuo to give resin 51 as dark brown granules (1.25 g).

Elemental analysis: C, 77.1%; H, 7.0%; N, 1.0%; F, 2.2%; Ge, 2.5%
Deprotection of Silyl Protected Resin 51 to Give Resin 52 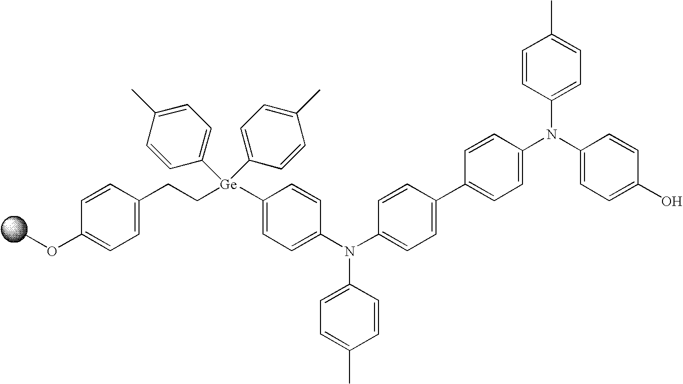
This compound was prepared according to procedure F. Resin 51 (0.94 g, 0.47×10⁻³ mol) and tetrabutylammonium fluoride (0.74 g, 2.35×10⁻³ mol) were added together with tetrahydrofuran (10 mL). After removal of the solvent by filtration, the resin was washed extensively with N,N-dimethylformamide (1×30 mL), tetrahydrofuran/water (1:1) (2×30 mL), tetrahydrofuran (2×30 ml), methanol (2×30 mL) and was dried for 16 h at 50° C. under vacuo to give resin 52 as dark brown granules (0.91 g).

Elemental analysis: C, 78.5%; H, 7.0%; N, 1.0%; Ge, 2.4%
Triflation of Resin Bound Arylamine 52 to Give Resin 53 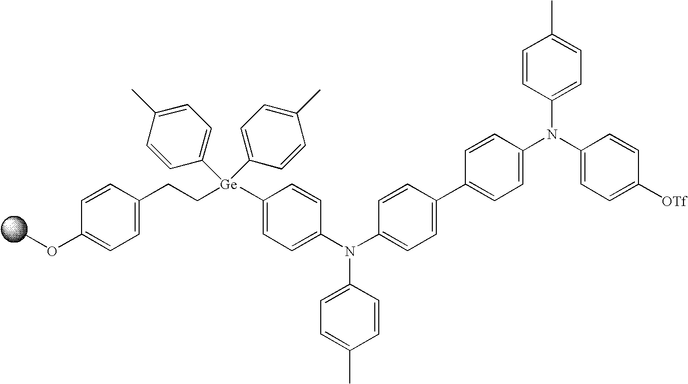
This compound was prepared according to procedure G. Resin 52 (0.70 g, 0.35×10⁻³ mol) and trifluoromethanesulfonic anhydride (0.30 mL, 1.75×10⁻³ mol) were added together in tetrahydrofuran (10 mL). After removal of the solvent by filtration, the resin was washed extensively with N,N-dimethylformamide (1×30 mL), tetrahydrofuran/water (1:1) (2×30 mL), tetrahydrofuran (2×30 mL), methanol (2×30 mL) and was dried for 16 h at 50° C. under vacuo to give resin 53 as brown granules (0.65 g).

Elemental analysis: C, 67.9%; H, 6.3%; N, 1.1%; S, 1.1%; Ge, 2.2%
Suzuki Cross-Coupling on Resin 53 to Give Resin 54 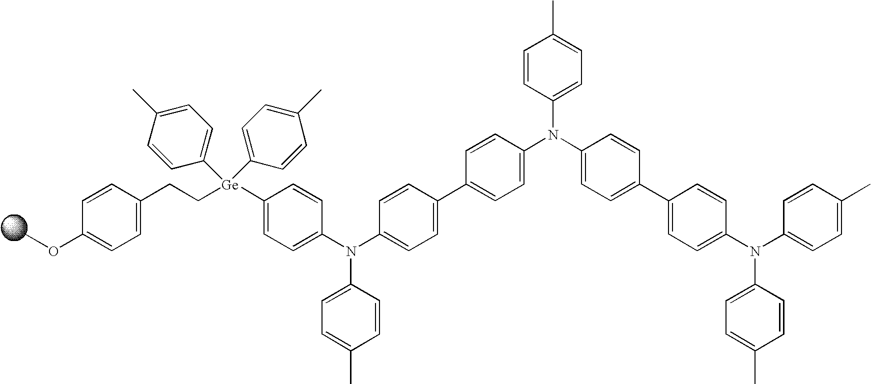
This compound was prepared according to procedure H. Resin 53 (0.53 g, 0.35×10⁻³ mol) was reacted in 1,2-dimethoxyethane (5 mL) with 27 (1.73 g, 3.35×1104 mol), Pd(PPh₃)₄ (0.15 g, 0.13×10⁻³ mol) and aqueous Na₂CO₃ (2M) (5 mL). After removal of the solvent by filtration, the resin was washed extensively with N,N-dimethylformamide (1×30 mL), tetrahydrofuran/water (1:1) (2×30 mL), tetrahydrofuran (2×30 mL), methanol (2×30 mL) and was dried for 16 h at 50° C. under vacuo to give resin 54 as brown granules (0.47 g).

Elemental analysis: C, 72.0%; H, 6.2%; N, 1.3%; Ge, 2.2%

### Cleavage of Resin 54 to Give N^{4′}-[4′-(Di-p-tolylamino-biphenyl-4-yl]-N⁴-(4′-phenyl)-N⁴, N^{4′}-di-p-tolyl-biphenyl-4,4′-diamine 55

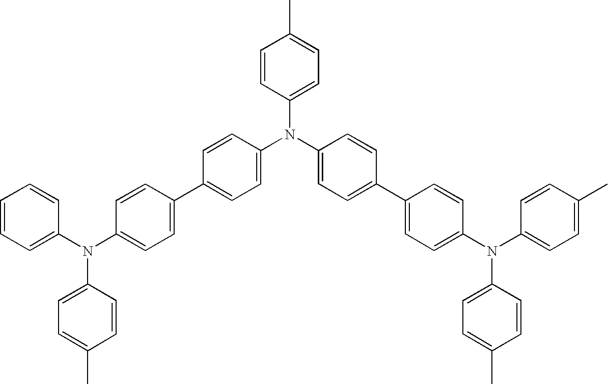 A suspension of resin 54 (0.33 g) in trifluoroacetic acid (10 % in dichloromethane) (5 mL) was stirred at room temperature for 16 h. The resin was separated off by filtration and washed with dichloromethane. The organic washings were concentrated 50° C. under vacuo to give a dark brown oil. Purification by column chromatography (eluent ethylacetate:hexane 1:20) gave the expected product which was confirmed by ¹H and ¹³C nmr spectroscopy.

1. A method for preparing a conjugated molecule comprising a first monomer coupled to a second monomer, said method comprising:
(i) linking the first monomer to a solid support via the germanium atom of a germyl linking group;
(ii) coupling the first monomer to the second monomer in a coupling position to form a bound conjugated molecule, wherein the second monomer has a protecting group in a non-coupling position;
(iii) optionally sequentially coupling a third, fourth . . . and n^{th} monomer to the second, third and (n-1)^{th} monomer respectively;
(iv) removing the protecting group; and
(v) ipso-degermylation to release the bound conjugated molecule.

2. A process for preparing a conjugated molecule comprising a first monomer coupled to a second monomer, said method comprising:
(A) linking the first monomer to a solid support via the germanium atom of a germyl linking group and, if necessary, activating a position on the first monomer
(B) coupling the first monomer to a second monomer in a coupling position to form a bound conjugated molecule, wherein the second monomer has a protecting group in a non-coupling position
(C) optionally removing the protecting group and repeating (B) with one or more further monomer molecules one or more times, optionally using monomer molecules without protecting groups or removing protecting groups as required if present
(D) if desired removing a protecting group if present; and
(E) ipso-degermylation to release the bound conjugated molecule.

3. A process according to claim 2 in which the coupling of (B) is repeated at least once to obtain a higher degree of conversion.

4. A process according to claim 2 in which each of the monomers contributes to a π-system of the conjugated molecule.

5. A process according to claim 2 in which each of the monomers is independently selected from the group consisting of aromatic carbocyclic monocyclic or polycyclic (eg fused polycyclic) monomers which are optionally ring substituted, unsaturated monocyclic or polycyclic (eg fused polycyclic) heterocyclic (eg heteroaromatic) monomers which are optionally ring substituted, and unsaturated acyclic hydrocarbon bridging monomers.

6. A process according to claim 5 in which one or more of the monomers has a ring substituent which enhances properties, for example, the electronic properties, of the conjugated molecule.

7. A process according to claim 2 in which the conjugated polymer is a polyheterocycle, wherein at least one of the monomers (preferably at least the first monomer) is ring substituted.

8. A process according to claim 5 in which at least one of the monomers is a 5- or 6-membered optionally ring substituted heterocyclic monomer unit which may contain one, two or three heterocyclic atoms which may be the same or different.

9. A process according to claim 5 in which the (or each) heterocyclic atom is selected from the group consisting of nitrogen, sulphur, oxygen, phosphorous and selenium.

10. A process according to claim 9 in which the (or each) heterocyclic atom is nitrogen or sulphur.

11. A process according to claim 2 in which at least one monomer group of formula —Ar′NAr′″Ar″— is present, the groups Ar′, Ar″ and Ar′″ being aryl groups, in which the aryl groups may be phenyl groups.

12. A process according to claim 11 in which Ar′″ is substituted (eg o- or p-substituted) with a group which has an electron withdrawing or donating effect.

13. A process according to claim 11 in which Ar′″ has a substituent which enhances the solubility of the conjugated compound in aromatic or chlorinated solvents.

14. A process according to claim 2 in which at least one of the monomers is thiophene which may be substituted at the 3- or 4-position with an alkyl group (eg a C₁₋₁₂-alkyl such as a hexyl or octyl) or an aryl (eg a phenyl) group.

15. A process according to claim 2 in which the protecting groups are silyl groups of formula SiR′R″R′″ in which R′, R″ and R′″ are independently alkyl groups having 1 to 4 carbon atoms or phenyl groups for example Me₃Si, Et₃Si, ⁱPr₃Si, Me₂PhSi and preferably Me₂^{t}BuSi (TBDMS) or corresponding silyloxy groups.

16. A process according to claim 15 in which the silyl protecting group is removed in step (D) nucleophilically with a basic source (eg K₃ PO₄ or Cs₂CO₃) and/or a fluoride source (eg CsF or ⁿBu₄NF).

17. A process according to claim 2 in which the ipso-degermylation of step (E) is an ipso-protodegermylation i.e. cleavage in which the germanium link is replaced by a proton.

18. A process according to claim 17 in which an electrophilic ipso-degermylation (eg ipso-halodegermylation) is carried out.

19. A process according to claim 17 in which ipso-protodegermylation is carried out using a strong organic acid (for example trifluoroacetic acid (TFA), HCO₂H, AcOH, ClCH₂CO₂H or Cl₂CHCO₂H), a mineral acid (for example HCl, H₂SO₄ or HF) or a source of fluoride ions (for example CsF or Bu₄NF).

20. A process according to claim 19 which is carried out under mild conditions wherby silyl groups are not removed.

21. A process according to claim 19 in which the electrophilic ipso-degermylation is carried out using a source of halonium ions (F⁺, Cl⁺, Br⁺ or I⁺), NO⁺, NO₂⁺, SO₃⁺, RCO⁺, RSO₂⁺, BHal₂⁺(eg BCI₂⁺) or B(OH)₂⁺.

22. A process according to claim 17 in which degermylation is carried out under mild conditions whereby the protecting group is left intact to release a protected conjugated molecule.

23. A process according to claim 21 in which the protecting group is subsequently removed in step (D) using a different electrophile to produce an unsymmetrical conjugated molecule.

24. A process according to claim 17 in which the protecting group is removed simultaneously with degermylation (eg electrophilic ipso-desilylation) releasing a symmetrically end functionalised conjugated molecule.

25. A process according to claim 2 in which step (E) comprises: ipso-degermylation using an electrophilic group E to release the bound conjugated molecule with an end functionality E; and then reacting the conjugated molecule having end functionality E with a compound A′Y′ wherein group Y′ is capable of displacing end functionality E.

26. A process according to claim 25 in which the end functionality E is bromine, iodine or a boronic group such as a boronic acid group or a derivative thereof (eg an ester derivative thereof) for example a boronic acid group of formula —B(OR)ₙ (wherein: n is 2 or 3; and each R is independently hydrogen or an optionally substituted linear or branched C₁₋₆ alkyl group or two groups R represent an optionally substituted alkano bridging group between two oxygen atoms, for example, an optionally substituted ethano or propano bridging group).

27. A process according to claim 25 in which Group Y′ is an end capping group for example a linear or branched alkyl (eg C₁₋₆-alkyl), aryl, benzyl, vinyl, propargyl, allyl or alkynyl group or a conjugated molecule such as an oligoheterocyclic group.

28. A process according to claim 25 in which Y′ is a functionalised block conjugated polymer or oligomer group for example a block of thiophene or pyridine units and A′ is bromine, iodine or an organometallic functionality for example an organomagnesium, organozinc or organotin functionality or preferably an organoboron functionality eg B(OR^{y})ₙ, particularly preferably B(OH)₂ wherein: n is 2 or 3; and each R is independently hydrogen or an optionally substituted linear or branched Cl-alkyl group or two groups R represent an optionally substituted alkano bridging group between two oxygen atoms.

29. A process according to any claim 2 in which step (B) comprises halogenating the first monomer in a coupling position; and reacting the product with the second monomer metallated in a coupling position or metallating the first monomer in a coupling position; and reacting the product with the second monomer halogenated in a coupling position.

30. A process according to claim 29 in which the halogenation is carried out using bromine or iodine or a source thereof preferably 1,2-diiodoethane, optionally in the presence of a mercury salt such as acetate or hexanoate.

31. A process according to claim 29 or 30 in which the first or second monomer is metallated at its coupling position with a metallic group, for example selected from organoboron, organomagnesium, organotin and organozinc groups.

32. A process according to claim 31 in which the boronic group is a boronic ester group or preferably a hypervalent boronate complex.

33. A process according to claim 31 in which the boronic group is a boronic acid group or derivative thereof.

34. A process according to claim 31, 32 or 33 in which the boronic group is of formula:
—B(OR^{y})ₙ
wherein: n is 2 or 3; and each R^{y} is independently hydrogen or an optionally substituted linear or branched C₁₋₄-alkyl group or two groups R^{y} represent an optionally substituted alkano bridging group between two oxygen atoms.

35. A process according to claim 32 in which the hypervalent boronate complex is a hypervalent alkyl boronate complex with a suitable metal counterion (eg Na or (preferably) Li).

36. A process according to claim 29 in which the first monomer is metallated (preferably lithiated) in the chosen position and reacted with an immobilised germyl linking group which has a suitable leaving group which is preferably chloride.

37. A process as claimed in claim 2 in which one monomer is a compound of formula:
[X—B(OR)₃]M
wherein: M is a counter ion; for example an alkali metal, for example Na or Li, X is an optionally ring substituted unsaturated monocyclic or polycyclic (eg a fused polycyclic) hydrocarbon or heterocyclic moiety which may be linked to the germanium atom; and each group R is independently hydrogen or an optionally substituted linear or branched C₁₋₆-alkyl group or two groups R represent an optionally substituted alkano bridging group between two oxygen atoms.

38. A process according to claim 37 in which the group X is a ring substituted heterocyclic moiety which may contain one, two or three heterocyclic atoms which may be the same or different and are preferably selected from the group consisting of nitrogen, sulphur, oxygen, phosphorous and selenium, preferably the group consisting of nitrogen, oxygen and sulphur, and more preferably the group consisting of nitrogen and sulphur.

39. A process according to claim 37 or 38 in which the heterocyclic moiety is a 5- or 6-membered optionally ring substituted heterocyclic moiety preferably selected from the group consisting of optionally ring substituted thiophene, furan, pyridine, imidazole, isothiazole, isooxazole, pyran, pyrazine, pyridazine, pyrazole, pyridine, pyrimidine, triazole, oxadiazole, pyrrole, indazole, indole, indolizine, pyrrolizine, quinazoline, quinoline and phenyl.

40. A process according to claim 37 in which the heterocyclic moiety is selected from the group consisting of optionally ring substituted thiophene and pyridine and preferably thiophene which may be substituted at the 3-position with an alkyl group (eg a C₁₋₈-alkyl such as a hexyl or octyl) or an aryl (eg a phenyl) group.

41. A solid support for carrying out a process as claimed in any preceding claim of formula X(OR^{x}—GeR¹R² Hal)n in which X is a high molecular weight material of low solubility in water and organic solvents, suitably a hydrocarbon resin substituted by alkoxy chains, for example polystyrene substituted by alkoxy, preferably propoxy or more preferably ethoxy or propoxy/ethoxy chains, R^{x} is a hydrocarbon group suitably having 1 to 12 and more preferably 3 to 10 carbon atoms, for example an alkyl, aryl group or arylalkyl group, the aryl group suitably comprising a benzene ring optionally substituted by alkyl groups, the Ge being preferably linked to an alkyl group, R¹ and R² individually being alkyl or aryl groups for example phenyl or tolyl groups, preferably having 1 to 10 carbon atoms and Hal representing a halide for example a bromide, iodide or preferably chloride atom and n being a large integer.

42. A solid support as claimed in claim 41 in which R¹ and/or R² is an aryl group substituted by an electronegative group which advantageously improves the efficiency of subsequent germanium cleavage.

43. A solid support according to claim 42 in which the electronegative group is an alkoxy or halogen group wherein the alkoxy group contains 1 to 6 carbon atoms.

44. A process according to claim 2 in which the support is as claimed in claim 41.
